(19) United States
(12) Patent Application Publication
(10) Pub. No.: US 2026/0059455 A1
(43) Pub. Date: Feb. 26, 2026

(54) POWER CONTROL FRAMEWORK

(71) Applicant: QUALCOMM Incorporated, San Diego, CA (US)

(72) Inventors: Akash Sandeep DOSHI, San Diego, CA (US); Wei YANG, San Diego, CA (US); June NAMGOONG, San Diego, CA (US); Jing JIANG, San Diego, CA (US); Taesang YOO, San Diego, CA (US); Danlu ZHANG, San Diego, CA (US)

(21) Appl. No.: 18/815,294

(22) Filed: Aug. 26, 2024

(51) Int. Cl. H04W 52/22; H04W 52/32; H04W 52/36

(52) U.S. Cl. CPC H04W 52/22; H04W 52/325; H04W 52/36

(57) ABSTRACT

Various aspects of the present disclosure generally relate to wireless communication. In some aspects, a user equipment (UE) may receive first information for a power shaping operation. The UE may perform, for a codebook and in accordance with the first information, the power shaping operation for each codeword from a set of codewords included in the codebook. The UE may receive second information for a power control operation. The UE may perform, for the codebook, the power control operation in accordance with the second information, the power control operation being common to all codewords included in the codebook. The UE may transmit, in accordance with the power shaping operation and the power control operation, control channel data that is encoded using the codebook. Numerous other aspects are described.

### FIELD OF THE DISCLOSURE

Aspects of the present disclosure generally relate to wireless communication and specifically relate to techniques, apparatuses, and methods for a power control framework.

### BACKGROUND

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

The above multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, high-precision positioning, and/or radio frequency (RF) sensing, among other examples. As the demand for mobile broadband access continues to increase, further improvements in NR may be implemented, and other radio access technologies such as 6G may be introduced, to further advance mobile broadband evolution.

### SUMMARY

In some aspects, an apparatus configured for wireless communication includes one or more memories comprising processor-executable instructions; and one or more processors configured to execute the processor-executable instructions and cause the apparatus to: receive first information for a power shaping operation; perform, for a codebook and in accordance with the first information, the power shaping operation for each codeword from a set of codewords included in the codebook; receive second information for a power control operation; perform, for the codebook, the power control operation in accordance with the second information, the power control operation being common to all codewords included in the codebook; and transmit, in accordance with the power shaping operation and the power control operation, control channel data that is encoded using the codebook.

In some aspects, an apparatus configured for wireless communication includes one or more memories comprising processor-executable instructions; and one or more processors configured to execute the processor-executable instructions and cause the apparatus to: transmit, for a user equipment (UE), first information for a power shaping operation; perform, for a codebook and in accordance with the first information, the power shaping operation for each codeword from a set of codewords included in the codebook; transmit second information for a power control operation; perform, for the codebook, the power control operation in accordance with the second information, the power control operation being common to all codewords included in the codebook; and receive, in accordance with the power shaping operation and the power control operation, a control channel data that is encoded using the codebook.

In some aspects, a method of wireless communication performed by a UE includes receiving first information for a power shaping operation; performing, for a codebook and in accordance with the first information, the power shaping operation for each codeword from a set of codewords included in the codebook; receiving second information for a power control operation; performing, for the codebook, the power control operation in accordance with the second information, the power control operation being common to all codewords included in the codebook; and transmitting, in accordance with the power shaping operation and the power control operation, control channel data that is encoded using the codebook.

In some aspects, a method of wireless communication performed by a network node includes transmitting, for a UE, first information for a power shaping operation; performing, for a codebook and in accordance with the first information, the power shaping operation for each codeword from a set of codewords included in the codebook; transmitting second information for a power control operation; performing, for the codebook, the power control operation in accordance with the second information, the power control operation being common to all codewords included in the codebook; and receiving, in accordance with the power shaping operation and the power control operation, a control channel data that is encoded using the codebook.

In some aspects, a non-transitory computer-readable medium storing a set of instructions for wireless communication includes one or more instructions that, when executed by one or more processors of a UE, cause the UE to: receive first information for a power shaping operation; perform, for a codebook and in accordance with the first information, the power shaping operation for each codeword from a set of codewords included in the codebook; receive second information for a power control operation; perform, for the codebook, the power control operation in accordance with the second information, the power control operation being common to all codewords included in the codebook; and transmit, in accordance with the power shaping operation and the power control operation, control channel data that is encoded using the codebook.

In some aspects, a non-transitory computer-readable medium storing a set of instructions for wireless communication includes one or more instructions that, when executed by one or more processors of a network node, cause the network node to: transmit, for a UE, first information for a power shaping operation; perform, for a codebook and in accordance with the first information, the power shaping operation for each codeword from a set of codewords included in the codebook; transmit second information for a power control operation; perform, for the codebook, the power control operation in accordance with the second information, the power control operation being common to all codewords included in the codebook; and receive, in accordance with the power shaping operation and the power control operation, a control channel data that is encoded using the codebook.

In some aspects, an apparatus for wireless communication includes means for receiving first information for a power shaping operation; means for performing, for a codebook and in accordance with the first information, the power shaping operation for each codeword from a set of codewords included in the codebook; means for receiving second information for a power control operation; means for performing, for the codebook, the power control operation in accordance with the second information, the power control operation being common to all codewords included in the codebook; and means for transmitting, in accordance with the power shaping operation and the power control operation, control channel data that is encoded using the codebook.

In some aspects, an apparatus for wireless communication includes means for transmitting, for a UE, first information for a power shaping operation; means for performing, for a codebook and in accordance with the first information, the power shaping operation for each codeword from a set of codewords included in the codebook; means for transmitting second information for a power control operation; means for performing, for the codebook, the power control operation in accordance with the second information, the power control operation being common to all codewords included in the codebook; and means for receiving, in accordance with the power shaping operation and the power control operation, a control channel data that is encoded using the codebook.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network, in accordance with the present disclosure.

FIG. 2 is a diagram illustrating an example network node in communication with an example user equipment (UE) in a wireless network, in accordance with the present disclosure.

FIG. 3 is a diagram illustrating an example disaggregated base station architecture, in accordance with the present disclosure.

FIG. 4 is a diagram illustrating an example of physical channels and reference signals in a wireless network, in accordance with the present disclosure.

FIG. 5 is a diagram illustrating an example of link adaptation, in accordance with the present disclosure.

FIG. 6 is a diagram of an example associated with a power control framework, in accordance with the present disclosure.

FIG. 7 is a diagram of an example associated with a power control framework, in accordance with the present disclosure.

FIG. 8 is a flowchart of an example method of wireless communication, in accordance with the present disclosure.

FIG. 9 is a flowchart of an example method of wireless communication, in accordance with the present disclosure.

FIG. 10 is a diagram of an example apparatus for wireless communication, in accordance with the present disclosure.

FIG. 11 is a diagram of an example apparatus for wireless communication, in accordance with the present disclosure.

FIG. 12 is a diagram illustrating an example of an implementation of code and circuitry for a communications device, in accordance with the present disclosure.

FIG. 13 is a diagram illustrating an example of an implementation of code and circuitry for a communications device, in accordance with the present disclosure.

### DETAILED DESCRIPTION

Various aspects of the present disclosure are described hereinafter with reference to the accompanying drawings. However, aspects of the present disclosure may be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

In some examples, a wireless communication device (e.g., a network node or a user equipment (UE)) may transmit a type of communication in which probabilities of certain types of information being included in a given communication are non-uniform. For example, the type of communication may include feedback information. The feedback information may include hybrid automatic repeat request (HARQ) feedback and/or a feedback codebook. In the context of feedback information (e.g., HARQ feedback), “codebook” refers to a set of one or more (e.g., a matrix of one or more) feedback indications (e.g., acknowledgement (ACK) or negative ACK (NACK) indications) that can be transmitted via a single transmission (e.g., a single uplink transmission). In some cases, the network entity (e.g., a UE) may support HARQ feedback codebook transmissions. A HARQ feedback codebook transmission may include a feedback message that the network entity is to transmit to another network entity to provide feedback regarding, for example, downlink data transmission (for example, transmissions associated with a downlink channel). As used herein, a codebook may be a sequence of bits, which may be constructed using ACK/NACK feedback associated with multiple communications (e.g., multiple downlink communications) that are received by a network entity during a feedback window. A codebook may include one or more codewords. A codeword may include a message or communication. For example, a codeword may include one or more ACK/NACK feedback indications (e.g., a sequence of one or more HARQ-ACK bit values and/or HARQ NACK bit values).

As described elsewhere herein, the wireless communication device may communicate using one or more communication parameters that are configured to achieve a target error rate for a given channel, such as a downlink channel. The wireless communication device may transmit data that is encoded using a codebook indicating feedback (e.g., HARQ ACK/NACK feedback) for the given channel. Because the communication parameter(s) are configured to achieve the target error rate (e.g., target block error rate (BLER)) for the given channel, the feedback information for the given channel will be biased and/or non-uniform. For example, if the target BLER for the given channel is 10%, then the probability that feedback is ACK feedback is 90% for a given communication (e.g., a given transport block) transmitted via the given channel. In some examples, codebooks may be designed for uniform probability of messages with equal likelihood of the bit 0 and bit 1. In such examples, power is applied uniformly to all codewords in the codebook. For example, each codeword may be transmitted using the same transmit power. This results in inefficient power usage by the wireless communication device transmitting the codebook.

In some examples, the wireless communication device may utilize techniques for power shaping associated with non-uniform message transmissions to improve power savings. For example, more power may be proportionately assigned to less likely symbols (e.g., less likely codewords) and less power to more likely symbols (e.g., more likely codewords) to reduce the average transmit power and improve error performance (e.g., to reduce the average transmit power associated with meeting a given target error rate). For example, the wireless communication device may scale a power of a codeword based on, or otherwise associated with, a probability associated with the codeword. As an example, the wireless communication device (e.g., a first wireless communication device) may perform a power scaling procedure for the codeword c(x^{k}) based on a power shaping parameter. In some examples, a second wireless communication device may receive the power shaping parameter from the first wireless communication device. In some examples, the power shaping parameter may be associated with a non-uniform probability of respective portions of the message x^{k}. For example, the power shaping procedure may use a power shaping parameter of

$$log ( \frac{1}{p ( {x}^{k} )} ) ,$$

where p(x^{k}) is the non-uniform probability of the message x^{k}. The message x^{k} may include one or more feedback indications, such as HARQ-ACK indications or HARQ NACK indications, among other examples. In other words, if a codeword c has probability π_{c}, then the transmit power allocated to that codeword may be proportional to the probability associated with the codeword (e.g., P_{c}∝−log π_{c}, where P_{c} is a power shaping parameter).

The use of a power shaping operation (e.g., a per-codeword power shaping operation or scheme as described in more detail elsewhere herein) for control channel data (e.g., HARQ information, uplink control information (UCI), channel state information (CSI), scheduling request (SR) data, or other control channel data) introduces additional considerations that are not present when only analog power control (e.g., codeword agnostic power control) is used. For example, To ensure reliable channel estimation, one or more network entities may use a traffic-to-pilot power ratio (TPR). The TPR indicates a ratio between a first transmit power of pilot signals transmitted via a channel and a second transmit power of data (or payload) signals transmitted via the channel (e.g., a ratio between the power allocated to data traffic and the power allocated to the pilot signals for a given channel). The TPR may impact channel estimation accuracy, beamforming performance, spectral efficiency, interference mitigation, and/or dynamic resource allocation, among other examples. In examples where a codebook uses uniform power for all codewords, the TPR may be a static value. For example, the TPR may be based on a quantity of code division multiplex (CDM) groups per resource element in a pilot signal (e.g., a demodulation reference signal (DMRS)) as compared to a quantity of CDM groups per resource element in data traffic. As an example, for a physical uplink control channel (PUCCH), where the pilot signal (e.g., the DMRS) and data traffic both have the rank 1, the TPR may be 0 decibels (dB). However, where power scaling or power shaping is applied to vary the transmit power for codewords in a codebook (e.g., based on the nonuniform probabilities of respective codewords), the TPR may vary over time based on the power scaling or power shaping being applied. As a result, network entities that are communicating may be unaware of a TPR for a given channel at a given time. The varying TPR (e.g., that may have a value different than 0 dB) may negatively impact the performance of channel estimation accuracy, beamforming performance, spectral efficiency, interference mitigation, and/or dynamic resource allocation, among other examples.

As another example, a network node may use performance parameters (e.g., key performance indicators (KPIs)) that are associated with (or specific to) control channel data that is associated with the power shaping operation. For example, a performance parameter may include an unequal error protection (UEP) parameter. Different issues may arise from errors in decoding ACK or NACK bits. Erroneously decoding an ACK as a NACK would only result in increasing overhead owing to retransmission. However, erroneously decoding a NACK as an ACK would lead to an unrecoverable decoding error for the communication associated with the HARQ feedback. Accordingly, UEP to prioritize correctly decoding NACKs over correctly decoding ACKs may be desirable for increasing network reliability and decreasing network latency. “Unequal error protection” or “UEP” refers to enforcing or targeting different error rates for different types of bits to protect some bits more than others. In some examples, it may be desirable to achieve UEP with a first bit error rate (BER) for decoding NACK bits (e.g., BER_{NACK}=0.1%) that is lower than a second BER for decoding ACK bits (e.g., BER_{ACK}=1%) in order to prioritize correctly decoding NACKs over correctly decoding ACKs. However, given a digital power shaping operation that applies per-codeword power shaping, existing techniques (e.g., analog power control techniques) cannot be used to achieve UEP for control channel data (e.g., that is encoded using a codebook for which per-codeword power shaping is applied).

Various aspects relate generally to a power control framework. Some aspects more specifically relate to a signaling framework to enable a power shaping operation and a power control operation for a codebook that is used to encode control channel data. In some aspects, a network node may transmit, and a UE may receive, first information for a power shaping operation (e.g., a digital power shaping operation and/or a per-codeword power shaping operation). The UE may perform, for a codebook and in accordance with the first information, the power shaping operation for each codeword from a set of codewords included in the codebook. The network node may transmit, and the UE may receive, second information for a power control operation (e.g., an analog power control operation that is common to all codewords in the codebook). The UE may perform the power control operation in accordance with the second information. The UE may transmit, and the network node may receive, in accordance with the power shaping operation and the power control operation, control channel data that is encoded using the codebook.

Particular aspects of the subject matter described in this disclosure can be implemented to realize one or more of the following potential advantages. In some examples, by signaling the first information and the second information, the described techniques can be used to improve the likelihood that the UE is able to perform both the power shaping operation and the power control operation in a synchronized manner with the network node (e.g., by using information and/or parameters expected or indicated by the network node). This improves the performance of the control channel data because the first information may enable the UE to perform the power shaping operation (e.g., enabling improved power savings for the control channel data) and the second information may enable the UE to perform the power control operation (e.g., enabling the power of the control channel data to be adjusted based on the power shaping operation or other considerations) in a coordinated and synchronized manner.

In some aspects, the second information may cause one or more transmit power parameters of the control channel data to meet one or more performance parameters. For example, the one or more performance parameters may be associated with the power shaping operation (e.g., may be defined or introduced as a result of the power shaping operation being performed). In some aspects, the one or more performance parameters may include an average TPR for a control channel transmission (e.g., that includes the control channel data), and/or an unequal error protection parameter, among other examples. By the network node transmitting, and the UE receiving, the second information, the UE may perform the power control operation to improve the likelihood that the one or more performance parameters are met (e.g., to improve the likelihood that the one or more transmit power parameters satisfy one or more thresholds or are within one or more ranges of values).

In some aspects, the first information may indicate a step gap (e.g., a value of a step gap). The step gap may be indicative of a difference (e.g., a maximum difference) in power levels in a codeword power vector associated with the power shaping operation (e.g., where the codeword power vector comprises only two distinct power levels). By including the step gap in the first information, the UE may obtain the codeword power vector without the network node signaling or indicating values for the power levels included in the codeword power vector (e.g., without the network node having to signal or indicate the value of each power level included in the codeword power vector), thereby reducing signaling overhead for the power shaping operation.

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (cMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, radio frequency (RF) sensing, and/or artificial intelligence or machine learning (AI/ML), among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

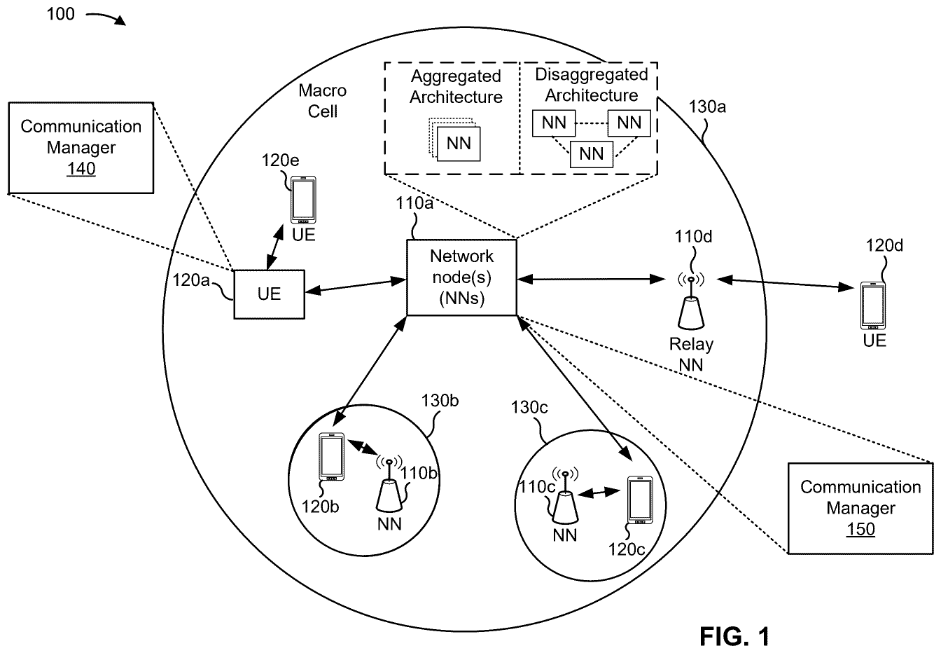

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120c.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHZ), FR2 (24.25 GHz through 52.6 GHZ), FR3 (7.125 GHz through 24.25 GHZ), FR4a or FR4-1 (52.6 GHz through 71 GHZ), FR4 (52.6 GHZ through 114.25 GHZ), and FR5 (114.25 GHz through 300 GHz). Although a portion of FR1 is greater than 6 GHz, FR1 is often referred to (interchangeably) as a “Sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHZ,” if used herein, may broadly refer to frequencies that are less than 6 GHZ, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/Long Term Evolution (LTE) and 5G/NR) are implemented with dynamic bandwidth allocation (for example, based on user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a radio access network (RAN).

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node may have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more central units (CUs), one or more distributed units (DUs), and/or one or more radio units (RUs). A CU may host one or more higher layer control functions, such as radio resource control (RRC) functions, packet data convergence protocol (PDCP) functions, and/or service data adaptation protocol (SDAP) functions, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (IFFT), beamforming, physical random access channel (PRACH) extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In some examples, a cell may not necessarily be stationary. For example, the geographic area of the cell may move according to the location of an associated mobile network node 110 (for example, a train, a satellite base station, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c. Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink channels may include one or more control channels and one or more data channels. A downlink control channel may be used to transmit downlink control information (DCI) (for example, scheduling information, reference signals, and/or configuration information) from a network node 110 to a UE 120. A downlink data channel may be used to transmit downlink data (for example, user data associated with a UE 120) from a network node 110 to a UE 120. Downlink control channels may include one or more physical downlink control channels (PDCCHs), and downlink data channels may include one or more physical downlink shared channels (PDSCHs). Uplink channels may similarly include one or more control channels and one or more data channels. An uplink control channel may be used to transmit UCI (for example, reference signals and/or feedback corresponding to one or more downlink transmissions) from a UE 120 to a network node 110. An uplink data channel may be used to transmit uplink data (for example, user data associated with a UE 120) from a UE 120 to a network node 110. Uplink control channels may include one or more PUCCHs, and uplink data channels may include one or more physical uplink shared channels (PUSCHs). The downlink and the uplink may each include a set of resources on which the network node 110 and the UE 120 may communicate.

Downlink and uplink resources may include time domain resources (frames, subframes, slots, and/or symbols), frequency domain resources (frequency bands, component carriers, subcarriers, resource blocks, and/or resource elements), and/or spatial domain resources (particular transmit directions and/or beam parameters). Frequency domain resources of some bands may be subdivided into bandwidth parts (BWPs). A BWP may be a continuous block of frequency domain resources (for example, a continuous block of resource blocks) that are allocated for one or more UEs 120. A UE 120 may be configured with both an uplink BWP and a downlink BWP (where the uplink BWP and the downlink BWP may be the same BWP or different BWPs). A BWP may be dynamically configured (for example, by a network node 110 transmitting a DCI configuration to the one or more UEs 120) and/or reconfigured, which means that a BWP can be adjusted in real-time (or near-real-time) based on changing network conditions in the wireless communication network 100 and/or based on the specific requirements of the one or more UEs 120. This enables more efficient use of the available frequency domain resources in the wireless communication network 100 because fewer frequency domain resources may be allocated to a BWP for a UE 120 (which may reduce the quantity of frequency domain resources that a UE 120 is required to monitor), leaving more frequency domain resources to be spread across multiple UEs 120. Thus, BWPs may also assist in the implementation of lower-capability UEs 120 by facilitating the configuration of smaller bandwidths for communication by such UEs 120.

As described above, in some aspects, the wireless communication network 100 may be, may include, or may be included in, an IAB network. In an IAB network, at least one network node 110 is an anchor network node that communicates with a core network. An anchor network node 110 may also be referred to as an IAB donor (or “IAB-donor”). The anchor network node 110 may connect to the core network via a wired backhaul link. For example, an Ng interface of the anchor network node 110 may terminate at the core network. Additionally or alternatively, an anchor network node 110 may connect to one or more devices of the core network that provide a core access and mobility management function (AMF). An IAB network also generally includes multiple non-anchor network nodes 110, which may also be referred to as relay network nodes or simply as IAB nodes (or “IAB-nodes”). Each non-anchor network node 110 may communicate directly with the anchor network node 110 via a wireless backhaul link to access the core network, or may communicate indirectly with the anchor network node 110 via one or more other non-anchor network nodes 110 and associated wireless backhaul links that form a backhaul path to the core network. Some anchor network node 110 or other non-anchor network node 110 may also communicate directly with one or more UEs 120 via wireless access links that carry access traffic. In some examples, network resources for wireless communication (such as time resources, frequency resources, and/or spatial resources) may be shared between access links and backhaul links.

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In this case, the wireless communication network 100 may include or be referred to as a “multi-hop network.” In the example shown in FIG. 1, the network node 110d (for example, a relay network node) may communicate with the network node 110a (for example, a macro network node) and the UE 120d in order to facilitate communication between the network node 110a and the UE 120d. Additionally or alternatively, a UE 120 may be or may operate as a relay station that can relay transmissions to or from other UEs 120. A UE 120 that relays communications may be referred to as a UE relay or a relay UE, among other examples.

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, Institute of Electrical and Electronics Engineers (IEEE) compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

Some UEs 120 may be considered machine-type communication (MTC) UEs, evolved or enhanced machine-type communication (eMTC), UEs, further enhanced cMTC (feMTC) UEs, or enhanced feMTC (efeMTC) UEs, or further evolutions thereof, all of which may be simply referred to as “MTC UEs”. An MTC UE may be, may include, or may be included in or coupled with a robot, an uncrewed aerial vehicle, a remote device, a sensor, a meter, a monitor, and/or a location tag. Some UEs 120 may be considered IoT devices and/or may be implemented as NB-IoT (narrowband IoT) devices. An IoT UE or NB-IoT device may be, may include, or may be included in or coupled with an industrial machine, an appliance, a refrigerator, a doorbell camera device, a home automation device, and/or a light fixture, among other examples. Some UEs 120 may be considered Customer Premises Equipment, which may include telecommunications devices that are installed at a customer location (such as a home or office) to enable access to a service provider's network (such as included in or in communication with the wireless communication network 100).

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between UEs 120 of the first category and UEs 120 of the second capability). A UE 120 of the third category may be referred to as a reduced capacity UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, and/or cameras that are associated with a limited bandwidth, power capacity, and/or transmission range, among other examples. RedCap UEs may support healthcare environments, building automation, electrical distribution, process automation, transport and logistics, and/or smart city deployments, among other examples.

In some examples, two or more UEs 120 (for example, shown as UE 120a and UE 120c) may communicate directly with one another using sidelink communications (for example, without communicating by way of a network node 110 as an intermediary). As an example, the UE 120a may directly transmit data, control information, or other signaling as a sidelink communication to the UE 120c. This is in contrast to, for example, the UE 120a first transmitting data in an UL communication to a network node 110, which then transmits the data to the UE 120e in a DL communication. In various examples, the UEs 120 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 110 may schedule and/or allocate resources for sidelink communications between UEs 120 in the wireless communication network 100. In some other deployments and configurations, a UE 120 (instead of a network node 110) may perform, or collaborate or negotiate with one or more other UEs to perform, scheduling operations, resource selection operations, and/or other operations for sidelink communications.

In various examples, some of the network nodes 110 and the UEs 120 of the wireless communication network 100 may be configured for full-duplex operation in addition to half-duplex operation. A network node 110 or a UE 120 operating in a half-duplex mode may perform only one of transmission or reception during particular time resources, such as during particular slots, symbols, or other time periods. Half-duplex operation may involve time-division duplexing (TDD), in which DL transmissions of the network node 110 and UL transmissions of the UE 120 do not occur in the same time resources (that is, the transmissions do not overlap in time). In contrast, a network node 110 or a UE 120 operating in a full-duplex mode can transmit and receive communications concurrently (for example, in the same time resources). By operating in a full-duplex mode, network nodes 110 and/or UEs 120 may generally increase the capacity of the network and the radio access link. In some examples, full-duplex operation may involve frequency-division duplexing (FDD), in which DL transmissions of the network node 110 are performed in a first frequency band or on a first component carrier and transmissions of the UE 120 are performed in a second frequency band or on a second component carrier different than the first frequency band or the first component carrier, respectively. In some examples, full-duplex operation may be enabled for a UE 120 but not for a network node 110. For example, a UE 120 may simultaneously transmit an UL transmission to a first network node 110 and receive a DL transmission from a second network node 110 in the same time resources. In some other examples, full-duplex operation may be enabled for a network node 110 but not for a UE 120. For example, a network node 110 may simultaneously transmit a DL transmission to a first UE 120 and receive an UL transmission from a second UE 120 in the same time resources. In some other examples, full-duplex operation may be enabled for both a network node 110 and a UE 120.

In some examples, the UEs 120 and the network nodes 110 may perform MIMO communication. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers, referred to as multi-user MIMO (MU-MIMO). Some RATs may employ advanced MIMO techniques, such as mTRP operation (including redundant transmission or reception on multiple TRPs), reciprocity in the time domain or the frequency domain, single-frequency-network (SFN) transmission, or non-coherent joint transmission (NC-JT).

In some aspects, the UE 120 may include a communication manager 140. As described in more detail elsewhere herein, the communication manager 140 may receive first information for a power shaping operation; perform, for a codebook and in accordance with the first information, the power shaping operation for each codeword from a set of codewords included in the codebook; receive second information for a power control operation; perform, for the codebook, the power control operation in accordance with the second information, the power control operation being common to all codewords included in the codebook; and transmit, in accordance with the power shaping operation and the power control operation, control channel data that is encoded using the codebook. Additionally, or alternatively, the communication manager 140 may perform one or more other operations described herein.

In some aspects, the network node 110 may include a communication manager 150. As described in more detail elsewhere herein, the communication manager 150 may transmit, for a UE, first information for a power shaping operation; perform, for a codebook and in accordance with the first information, the power shaping operation for each codeword from a set of codewords included in the codebook; transmit second information for a power control operation; perform, for the codebook, the power control operation in accordance with the second information, the power control operation being common to all codewords included in the codebook; and receive, in accordance with the power shaping operation and the power control operation, a control channel data that is encoded using the codebook. Additionally, or alternatively, the communication manager 150 may perform one or more other operations described herein.

As indicated above, FIG. 1 is provided as an example. Other examples may differ from what is described with regard to FIG. 1.

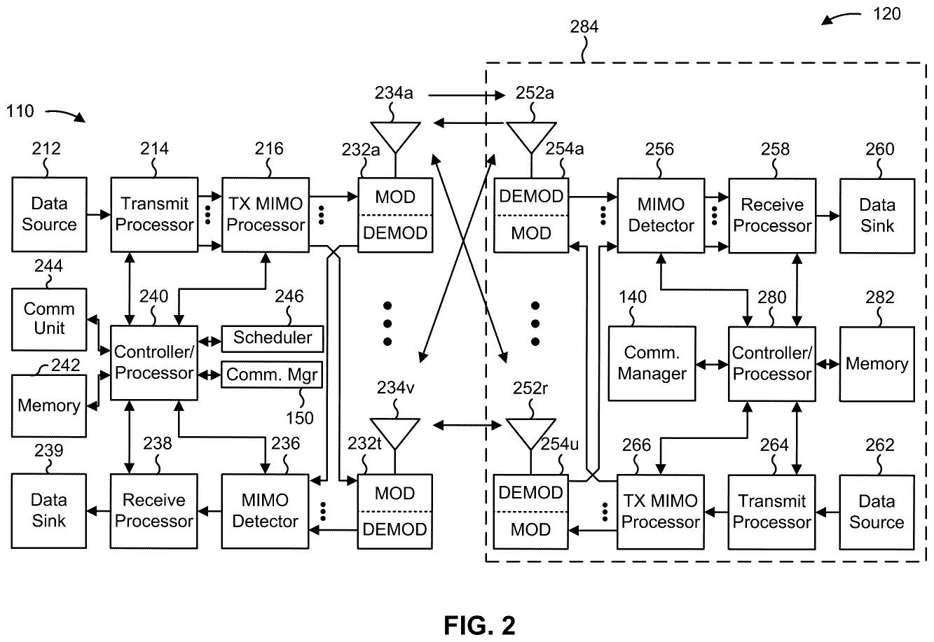

FIG. 2 is a diagram illustrating an example network node 110 in communication with an example UE 120 in a wireless network, in accordance with the present disclosure.

As shown in FIG. 2, the network node 110 may include a data source 212, a transmit processor 214, a transmit (TX) MIMO processor 216, a set of modems 232 (shown as 232a through 232t, where t≥1), a set of antennas 234 (shown as 234a through 234v, where v≥1), a MIMO detector 236, a receive processor 238, a data sink 239, a controller/processor 240, a memory 242, a communication unit 244, a scheduler 246, and/or a communication manager 150, among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 110. The transceiver may be under control of and used by one or more processors, such as the controller/processor 240, and in some aspects in conjunction with processor-readable code stored in the memory 242, to perform aspects of the methods, processes, and/or operations described herein. In some aspects, the network node 110 may include one or more interfaces, communication components, and/or other components that facilitate communication with the UE 120 or another network node.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

For downlink communication from the network node 110 to the UE 120, the transmit processor 214 may receive data (“downlink data”) intended for the UE 120 (or a set of UEs that includes the UE 120) from the data source 212 (such as a data pipeline or a data queue). In some examples, the transmit processor 214 may select one or more modulation and coding schemes (MCSs) for the UE 120 in accordance with one or more channel quality indicators (CQIs) received from the UE 120. The network node 110 may process the data (for example, including encoding the data) for transmission to the UE 120 on a downlink in accordance with the MCS(s) selected for the UE 120 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a DMRS, or a CSI reference signal (CSI-RS)) and/or synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing (OFDM)) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

A downlink signal may include a DCI communication, a MAC control element (MAC-CE) communication, an RRC communication, a downlink reference signal, or another type of downlink communication. Downlink signals may be transmitted on a PDCCH, a PDSCH, and/or on another downlink channel. A downlink signal may carry one or more transport blocks (TBs) of data. A TB may be a unit of data that is transmitted over an air interface in the wireless communication network 100. A data stream (for example, from the data source 212) may be encoded into multiple TBs for transmission over the air interface. The quantity of TBs used to carry the data associated with a particular data stream may be associated with a TB size common to the multiple TBs. The TB size may be based on or otherwise associated with radio channel conditions of the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

For uplink communication from the UE 120 to the network node 110, uplink signals from the UE 120 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 110 may use the scheduler 246 to schedule one or more UEs 120 for downlink or uplink communications. In some aspects, the scheduler 246 may use DCI to dynamically schedule DL transmissions to the UE 120 and/or UL transmissions from the UE 120. In some examples, the scheduler 246 may allocate recurring time domain resources and/or frequency domain resources that the UE 120 may use to transmit and/or receive communications using an RRC configuration (for example, a semi-static configuration), for example, to perform semi-persistent scheduling (SPS) or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some aspects, the RF chain may be or may be included in a transceiver of the network node 110.

In some examples, the network node 110 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 110 may use the communication unit 244 to transmit and/or receive data associated with the UE 120 or to perform network control signaling, among other examples. The communication unit 244 may include a transceiver and/or an interface, such as a network interface.

The UE 120 may include a set of antennas 252 (shown as antennas 252a through 252r, where r≥1), a set of modems 254 (shown as modems 254a through 254u, where u≥1), a MIMO detector 256, a receive processor 258, a data sink 260, a data source 262, a transmit processor 264, a TX MIMO processor 266, a controller/processor 280, a memory 282, and/or a communication manager 140, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some aspects in conjunction with processor-readable code stored in the memory 282, to perform aspects of the methods, processes, or operations described herein. In some aspects, the UE 120 may include another interface, another communication component, and/or another component that facilitates communication with the network node 110 and/or another UE 120.

For downlink communication from the network node 110 to the UE 120, the set of antennas 252 may receive the downlink communications or signals from the network node 110 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to the data sink 260 (which may include a data pipeline, a data queue, and/or an application executed on the UE 120), and may provide decoded control information and system information to the controller/processor 280.

For uplink communication from the UE 120 to the network node 110, the transmit processor 264 may receive and process data (“uplink data”) from a data source 262 (such as a data pipeline, a data queue, and/or an application executed on the UE 120) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 110 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a CQI parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an uplink DMRS, an uplink sounding reference signal (SRS), and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, U output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254u may transmit a set of uplink signals (for example, R uplink signals or U uplink symbols) via the corresponding set of antennas 252. An uplink signal may include a UCI communication, a MAC-CE communication, an RRC communication, or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 120 or network nodes 110 may include different numbers of antenna elements. For example, a UE 120 may include a single antenna element, two antenna elements, four antenna elements, eight antenna elements, or a different number of antenna elements. As another example, a network node 110 may include eight antenna elements, 24 antenna elements, 64 antenna elements, 128 antenna elements, or a different number of antenna elements. Generally, a larger number of antenna elements may provide increased control over parameters for beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

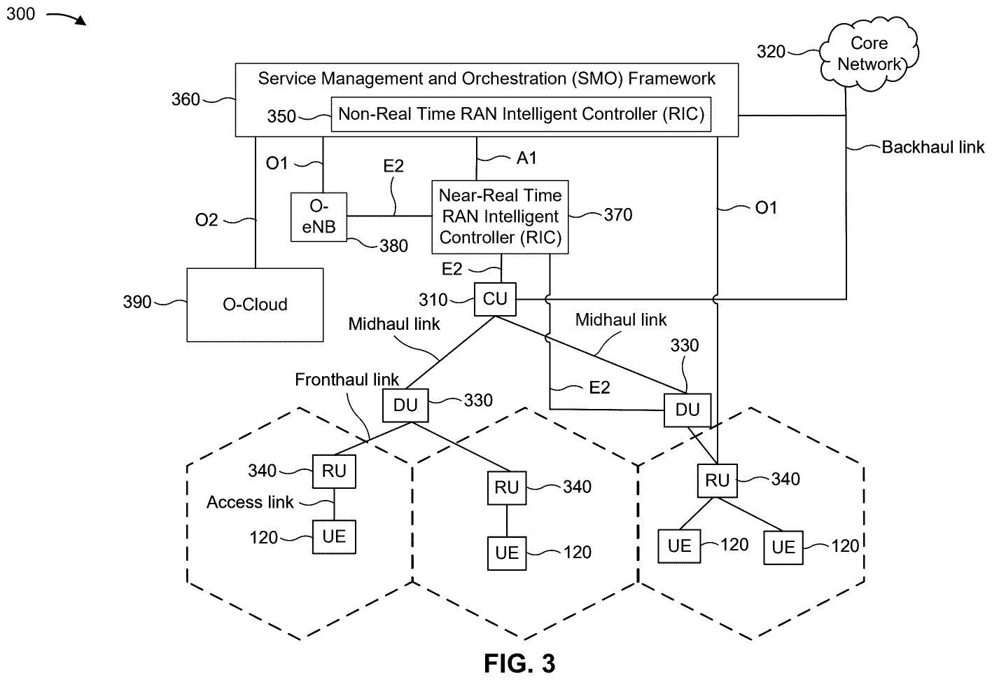

FIG. 3 is a diagram illustrating an example disaggregated base station architecture 300, in accordance with the present disclosure. One or more components of the example disaggregated base station architecture 300 may be, may include, or may be included in one or more network nodes (such one or more network nodes 110). The disaggregated base station architecture 300 may include a CU 310 that can communicate directly with a core network 320 via a backhaul link, or that can communicate indirectly with the core network 320 via one or more disaggregated control units, such as a Non-RT RIC 350 associated with a Service Management and Orchestration (SMO) Framework 360 and/or a Near-RT RIC 370 (for example, via an E2 link). The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 120 via respective RF access links. In some deployments, a UE 120 may be simultaneously served by multiple RUs 340.

Each of the components of the disaggregated base station architecture 300, including the CUs 310, the DUs 330, the RUs 340, the Near-RT RICs 370, the Non-RT RICs 350, and the SMO Framework 360, may include one or more interfaces or may be coupled with one or more interfaces for receiving or transmitting signals, such as data or information, via a wired or wireless transmission medium.

In some aspects, the CU 310 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330.

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 350, and/or a Near-RT RIC 370. In some aspects, the SMO Framework 360 may communicate with a hardware aspect of a 4G RAN, a 5G NR RAN, and/or a 6G RAN, such as an open eNB (O-eNB) 380, via an O1 interface. Additionally or alternatively, the SMO Framework 360 may communicate directly with each of one or more RUs 340 via a respective O1 interface. In some deployments, this configuration can enable each DU 330 and the CU 310 to be implemented in a cloud-based RAN architecture, such as a vRAN architecture.

The Non-RT RIC 350 may include or may implement a logical function that enables non-real-time control and optimization of RAN elements and resources, AI/ML workflows including model training and updates, and/or policy-based guidance of applications and/or features in the Near-RT RIC 370. The Non-RT RIC 350 may be coupled to or may communicate with (such as via an A1 interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, and/or an O-eNB with the Near-RT RIC 370.

In some aspects, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some examples, the Non-RT RIC 350 or the Near-RT RIC 370 may tune RAN behavior or performance. For example, the Non-RT RIC 350 may monitor long-term trends and patterns for performance and may employ AI/ML models to perform corrective actions via the SMO Framework 360 (such as reconfiguration via an O1 interface) or via creation of RAN management policies (such as A1 interface policies).

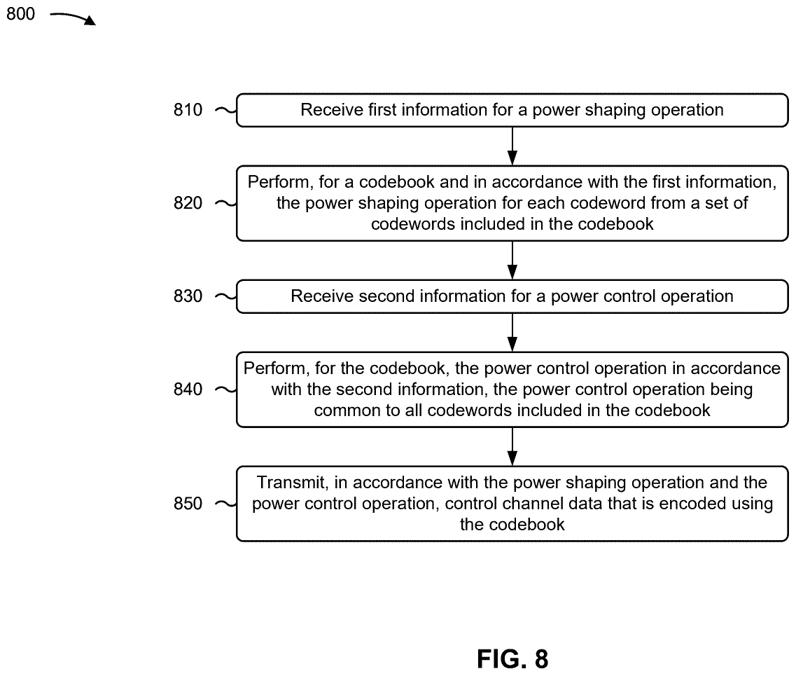

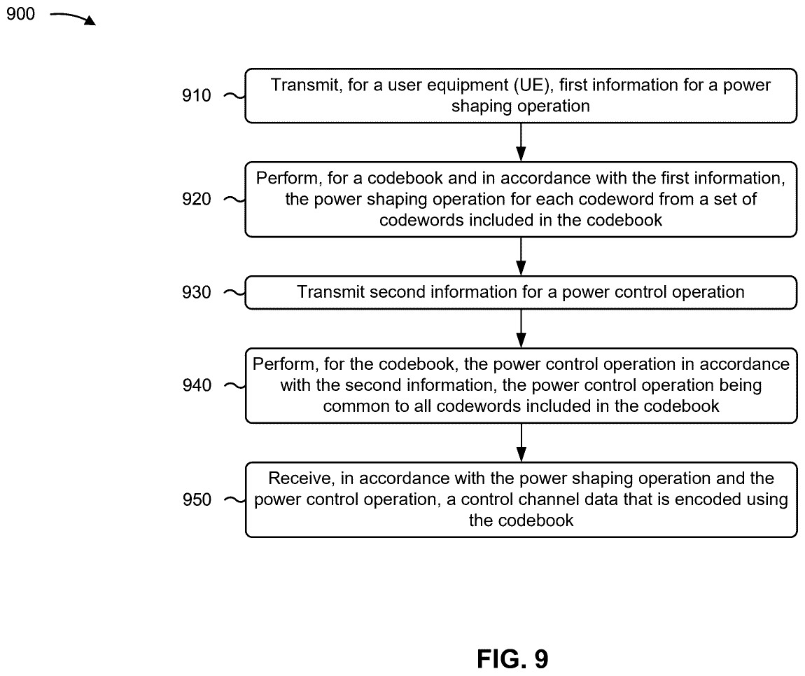

The network node 110, the controller/processor 240 of the network node 110, the UE 120, the controller/processor 280 of the UE 120, the CU 310, the DU 330, the RU 340, or any other component(s) of FIG. 1, 2, or 3 may implement one or more techniques or perform one or more operations associated with a power control framework, as described in more detail elsewhere herein. For example, the controller/processor 240 of the network node 110, the controller/processor 280 of the UE 120, any other component(s) of FIG. 2, the CU 310, the DU 330, or the RU 340 may perform or direct operations of, for example, method 800 of FIG. 8, method 900 of FIG. 9, or other processes or methods as described herein (alone or in conjunction with one or more other processors). The memory 242 may store data and program codes for the network node 110, the network node 110, the CU 310, the DU 330, or the RU 340. The memory 282 may store data and program codes for the UE 120. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 110, the UE 120, the CU 310, the DU 330, or the RU 340, may cause the one or more processors to perform method 800 of FIG. 8, method 900 of FIG. 9, or other processes or methods as described herein. In some examples, executing instructions may include running the instructions, converting the instructions, compiling the instructions, and/or interpreting the instructions, among other examples.

In some aspects, the UE 120 includes means for receiving first information for a power shaping operation; means for performing, for a codebook and in accordance with the first information, the power shaping operation for each codeword from a set of codewords included in the codebook; means for receiving second information for a power control operation; means for performing, for the codebook, the power control operation in accordance with the second information, the power control operation being common to all codewords included in the codebook; and/or means for transmitting, in accordance with the power shaping operation and the power control operation, control channel data that is encoded using the codebook. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for transmitting, for a UE, first information for a power shaping operation; means for performing, for a codebook and in accordance with the first information, the power shaping operation for each codeword from a set of codewords included in the codebook; means for transmitting second information for a power control operation; means for performing, for the codebook, the power control operation in accordance with the second information, the power control operation being common to all codewords included in the codebook; and/or means for receiving, in accordance with the power shaping operation and the power control operation, a control channel data that is encoded using the codebook. The means for the network node 110 to perform operations described herein may include, for example, one or more of communication manager 150, transmit processor 214, TX MIMO processor 216, modem 232, antenna 234, MIMO detector 236, receive processor 238, controller/processor 240, memory 242, or scheduler 246.

As indicated above, FIG. 3 is provided as an example. Other examples may differ from what is described with regard to FIG. 3.

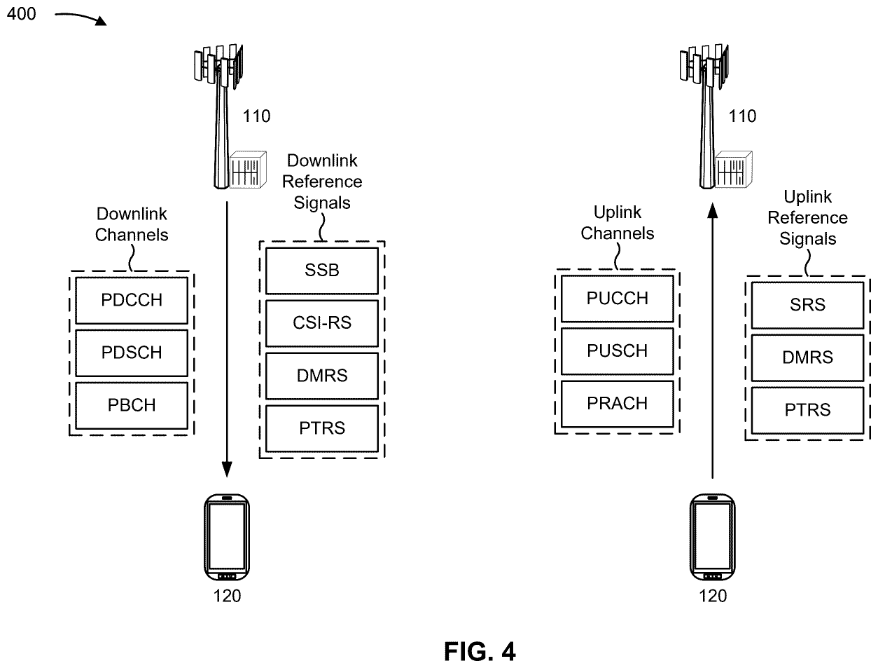

FIG. 4 is a diagram illustrating an example 400 of physical channels and reference signals in a wireless network, in accordance with the present disclosure. As shown in FIG. 4, downlink channels and downlink reference signals may carry information from a network node 110 to a UE 120, and uplink channels and uplink reference signals may carry information from a UE 120 to a network node 110.

As shown, a downlink channel may include a PDCCH that carries DCI, a PDSCH that carries downlink data, or a physical broadcast channel (PBCH) that carries system information, among other examples. In some aspects, PDSCH communications may be scheduled by PDCCH communications. As further shown, an uplink channel may include a PUCCH that carries UCI, a PUSCH that carries uplink data, or a PRACH used for initial network access, among other examples. In some aspects, the UE 120 may transmit ACK or NACK feedback (e.g., ACK/NACK feedback or ACK/NACK information) in UCI on the PUCCH and/or the PUSCH. The feedback may be HARQ feedback for data transmitted via the PDSCH or another downlink channel.

As further shown, a downlink reference signal may include a synchronization signal block (SSB), a CSI-RS, a DMRS, a positioning reference signal (PRS), or a phase tracking reference signal (PTRS), among other examples. As also shown, an uplink reference signal may include an SRS, a DMRS, or a PTRS, among other examples.

An SSB may carry information used for initial network acquisition and synchronization, such as a PSS, an SSS, a PBCH, and a PBCH DMRS. An SSB is sometimes referred to as a synchronization signal/PBCH (SS/PBCH) block. In some aspects, the network node 110 may transmit multiple SSBs on multiple corresponding beams, and the SSBs may be used for beam selection.

A CSI-RS may carry information used for downlink channel estimation (e.g., downlink CSI acquisition), which may be used for scheduling, link adaptation, or beam management, among other examples. The network node 110 may configure a set of CSI-RSs for the UE 120, and the UE 120 may measure the configured set of CSI-RSs. Based at least in part on the measurements, the UE 120 may perform channel estimation and may report channel estimation parameters to the network node 110 (e.g., in a CSI report), such as a CQI, a precoding matrix indicator (PMI), a CSI-RS resource indicator (CRI), a layer indicator (LI), a rank indicator (RI), or an RSRP, among other examples. The network node 110 may use the CSI report to select transmission parameters for downlink communications to the UE 120, such as a number of transmission layers (e.g., a rank), a precoding matrix (e.g., a precoder), an MCS, or a refined downlink beam (e.g., using a beam refinement procedure or a beam management procedure), among other examples.

A DMRS may carry information used to estimate a radio channel for demodulation of an associated physical channel (e.g., PDCCH, PDSCH, PBCH, PUCCH, or PUSCH). The design and mapping of a DMRS may be specific to a physical channel for which the DMRS is used for estimation. DMRSs are UE-specific, can be beamformed, can be confined in a scheduled resource (e.g., rather than transmitted on a wideband), and can be transmitted only when necessary. As shown, DMRSs are used for both downlink communications and uplink communications.

A PTRS may carry information used to compensate for oscillator phase noise. Typically, the phase noise increases as the oscillator carrier frequency increases. Thus, PTRS can be utilized at high carrier frequencies, such as millimeter wave frequencies, to mitigate phase noise. The PTRS may be used to track the phase of the local oscillator and to enable suppression of phase noise and common phase error (CPE). As shown, PTRSs are used for both downlink communications (e.g., on the PDSCH) and uplink communications (e.g., on the PUSCH).

A PRS may carry information used to enable timing or ranging measurements of the UE 120 based on signals transmitted by the network node 110 to improve observed time difference of arrival (OTDOA) positioning performance. For example, a PRS may be a pseudo-random quadrature phase shift keying (QPSK) sequence mapped in diagonal patterns with shifts in frequency and time to avoid collision with cell-specific reference signals and control channels (e.g., a PDCCH). In general, a PRS may be designed to improve detectability by the UE 120, which may need to detect downlink signals from multiple neighboring network nodes in order to perform OTDOA-based positioning. Accordingly, the UE 120 may receive a PRS from multiple cells (e.g., a reference cell and one or more neighbor cells), and may report a reference signal time difference (RSTD) based on OTDOA measurements associated with the PRSs received from the multiple cells. In some aspects, the network node 110 may then calculate a position of the UE 120 based on the RSTD measurements reported by the UE 120.

An SRS may carry information used for uplink channel estimation, which may be used for scheduling, link adaptation, precoder selection, or beam management, among other examples. The network node 110 may configure one or more SRS resource sets for the UE 120, and the UE 120 may transmit SRSs on the configured SRS resource sets. An SRS resource set may have a configured usage, such as uplink CSI acquisition, downlink CSI acquisition for reciprocity-based operations, uplink beam management, among other examples. The network node 110 may measure the SRSs, may perform channel estimation based at least in part on the measurements, and may use the SRS measurements to configure communications with the UE 120.

The UE 120 and the network node 110 may support retransmissions of data to increase the likelihood that data is received successfully. HARQ feedback is one technique for increasing the likelihood that data is received correctly via a communication link or channel. HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise ratio conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

A MAC layer of a protocol stack may implement a HARQ protocol to provide a faster retransmission mechanism relative to other retransmission mechanisms, such as an RLC layer retransmission system. In some aspects, the HARQ protocol may include a transmitting device using a retransmission protocol in combination with a receiving device, such as a send and wait (SAW) protocol that enables the receiving device to recover and/or correct data errors in a first HARQ process without hindering data transmissions in a second HARQ process. Accordingly, multiple HARQ processes may operate in parallel, and data errors identified in the first HARQ process may not hinder transmissions in the second HARQ process. Some non-limiting examples of transmitting device-receiving device pairs that may implement a HARQ process in combination may include a network node 110 and a UE 120 (e.g., a downlink HARQ process), a UE 120 and a network node 110 (e.g., an uplink HARQ process), and/or a first UE 120 and a second UE 120 (e.g., a sidelink HARQ process). Thus, a HARQ process may be used for downlink communications, uplink communications, and/or sidelink communications. In some aspects, and as part of a HARQ process, a network node may transmit information in DCI that indicates to a receiving device (e.g., a UE 120) which downlink transmission(s) and/or which uplink transmissions to process using a HARQ protocol. Alternatively, or additionally, and as part of the HARQ process, a first UE may transmit information in sidelink control information (SCI) that indicates, to a second UE, which sidelink transmission(s) to process using the HARQ protocol.

In some aspects, a HARQ process and/or HARQ protocol may enable a receiving device to correct errors in a received data packet, such as by correcting errors within a TB based at least in part on soft combining packets in a PHY layer as described below. In some aspects, a TB may be partitioned into one or more code block groups (CBGs), and each CBG may partitioned into one or more code blocks (CBs). To correct for errors, the receiving device may buffer one or more data packets that have been identified as including an error, combine the data packets, and process the combined data packets to reduce errors.

The UE 120 may receive downlink signaling from the network node 110. The UE 120 may transmit feedback messages for the downlink signaling. For example, the UE 120 may transmit a feedback codebook (e.g., a sequence of bits that indicate feedback for one or multiple downlink transmissions), such as a HARQ ACK or NACK codebook including feedback bits indicating ACK or NACK information for the received downlink signaling. The UE 120 may transmit the feedback (e.g., the feedback codebook) via an uplink channel, such as the PUCCH. In some examples, the UE 120 may be more likely to transmit an ACK indication (e.g., bit 0) than a NACK indication (e.g., bit 1). For example, at a 10% BLER in the PDSCH, the UE 120 may transmit 90% ACK indications and 10% NACK indications. However, current codebooks are designed for uniform probability of messages with equal likelihood of the bit 0 and bit 1, and power is applied uniformly to the non-uniform messages. This results in inefficient power utilization.

Therefore, in some examples, the UE 120 and/or the network node 110 may use a power shaping scheme for encoding and decoding control channel communications, such as data transmitted via the PUCCH. As described in more detail elsewhere herein, the power shaping scheme may be associated with the UE 120 determining a transmit power for codewords included in a codebook using a set of power shaping parameters. The set of power shaping parameters may be associated with respective codewords of the codewords included in a codebook. In other words, each codeword may have a dedicated power shaping parameter that has a value that is based on, or otherwise associated with, a probability of occurrence of that codeword, as described in more detail elsewhere herein.

As indicated above, FIG. 4 is provided as an example. Other examples may differ from what is described with regard to FIG. 4.

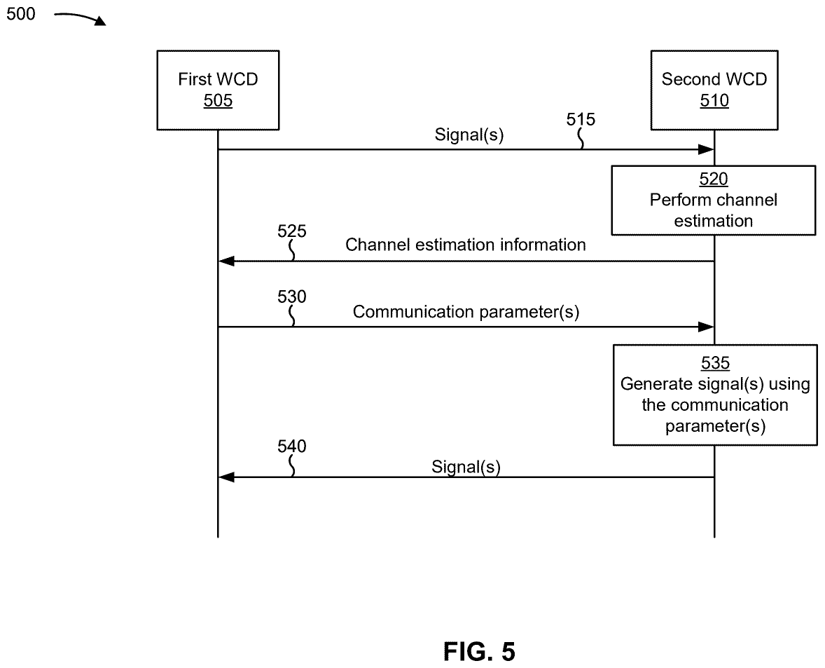

FIG. 5 is a diagram illustrating an example 500 of link adaptation, in accordance with the present disclosure. As shown in FIG. 5, a first wireless communication device (WCD) 505 (e.g., a UE 120 or a network node 110) may communicate with a second WCD 510 (e.g., a UE 120 or a network node 110). In some examples, the first WCD 505 may be a network node 110, and the second WCD 510 may be a UE 120. In other examples, the first WCD 505 and the second WCD 510 may be other types of wireless communication devices (e.g., both the first WCD 505 and the second WCD 510 may be UEs). The first WCD 505 and the second WCD 510 may communicate via a wireless communication network, such as the wireless communication network 100.

The first WCD 505 and the second WCD 510 may perform link adaptation to dynamically adjust communication parameters (e.g., transmission parameters) based on, in response to, or otherwise associated with, an estimated quality of a communication link, such as one or more communication channels (e.g., the PDSCH, the PUSCH, the PDCCH, and/or the PUCCH). For example, in a wireless communication network, channel conditions between the first WCD 505 and the second WCD 510 may vary due to one or more factors, such as a distance between the first WCD 505 and the second WCD 510, one or more obstacles in the environment (e.g., that may block or deflect transmitted beams or signals), and/or interference from other signals, among other examples. One example of link adaptation is outer-loop link adaptation (OLLA). Unlike inner-loop link adaptation, which adapts one or more parameters based on short-term variations in a channel, OLLA enables parameter adaptation based on longer-term variations, making OLLA more suitable for optimizing system performance over time.

For example, as shown by reference number 515, the first WCD 505 may transmit, and the second WCD 510 may receive, one or more signals. The one or more signals may include one or more reference signals, data signals, control signals, and/or other types of signals. The one or more signals may be transmitted via a communication channel, such as the PDSCH, the PDCCH, the PUSCH, and/or the PUCCH. As shown by reference number 520, the second WCD 510 may perform channel estimation based on, or using, the one or more signals. For example, the second WCD 510 may decode, measure, and/or otherwise process the one or more signals to estimate one or more channel estimation parameters. In some examples, the second WCD 510 may determine CSI based on measuring and/or otherwise processing the one or more signals. The one or more channel estimation parameters may include one or more CSI parameters, a CQI parameter, an RSRP parameter, an RSSI parameter, an RSRQ parameter, a TPC parameter, and/or another parameter.

As shown by reference number 525, the second WCD 510 may transmit, and the first WCD 505 may receive, channel estimation information (e.g., for the channel via which the one or more signals were transmitted as described in connection with reference number 515). The channel estimation information may include the one or more channel estimation parameters and/or CSI for the channel. For example, the channel estimation information may be included in a CSI report.

The first WCD 505 may determine, adjust, and/or set one or more communication parameters to be used by the second WCD 510 based on the channel estimation information. For example, the first WCD 505 may determine an appropriate MCS to be used by the second WCD 510 based on the channel estimation information. As another example, the first WCD 505 may determine a transmit power, one or more power control parameters, and/or a frame structure, among other examples, based on the channel estimation information. In some examples, the first WCD 505 may determine, adjust, and/or set one or more communication parameters to maintain or achieve a target error rate for data (e.g., a payload) transmitted via the channel (e.g., a target BLER). For example, the first WCD 505 may determine, adjust, and/or set one or more communication parameters based on the channel estimation information and/or based on feedback from the second WCD 510 (e.g., HARQ feedback) to maintain or achieve the target error rate.

As shown by reference number 530, the first WCD 505 may transmit, and the second WCD 510 may receive, the one or more communication parameters, such as an MCS, a transmit power, one or more power control parameters, among other examples. For example, the first WCD 505 may configure the second WCD 510 to use the one or more communication parameters. As shown by reference number 535, the second WCD 510 may generate one or more signals using the one or more communication parameters. As shown by reference number 540, the second WCD 510 may transmit, and the first WCD 505 may receive, the one or more signals (e.g., that were generated using the one or more communication parameters).

In some examples, the second WCD 510 may transmit, and the first WCD 505 may receive, feedback information. The feedback information may include HARQ feedback and/or a feedback codebook. In the context of feedback information (e.g., HARQ feedback), “codebook” refers to a set of one or more (e.g., a matrix of one or more) feedback indications (e.g., ACK or NACK indications) that can be transmitted via a single transmission (e.g., a single uplink transmission, such as via the PUCCH or the PUSCH). In some cases, a WCD (e.g., a UE) may support HARQ feedback codebook transmissions. A HARQ feedback codebook transmission may include a feedback message that the network entity is to transmit to another network entity to provide feedback regarding, for example, downlink data transmission (for example, transmissions associated with a PDSCH). The network entity may be configured with different types of codebooks, such as a Type-1 HARQ-ACK codebook or a Type-2 HARQ-ACK codebook. For example, the Type-1 HARQ-ACK codebook may be associated with a fixed, or static, size (for example, that is configured by the network entity). The Type-2 HARQ-ACK codebook may be associated with a dynamic size (for example, where the size of the Type-2 HARQ-ACK codebook is based at least in part on, or otherwise associated with, scheduling received by the network entity). Typically, if the network entity is configured to transmit a Type-1 HARQ-ACK codebook, the network entity may collect feedback for one or more communications (e.g., PDSCH communications) that are received by the network entity during a feedback window (for example, k time intervals, such as k slots, k subframes, or k symbols), and may transmit the Type-1 HARQ-ACK codebook indicating feedback (for example, ACK/NACK feedback) associated with the PDSCH communications that are received by the network entity during the feedback window. As used herein, a codebook may be a sequence of bits, which may be constructed using ACK/NACK feedback associated with multiple communications (e.g., multiple PDSCH communications) that are received by a network entity during a feedback window. A codebook may include one or more codewords. A codeword may include a message or communication. For example, a codeword may include one or more ACK/NACK feedback indications (e.g., a sequence of one or more HARQ-ACK bit values and/or HARQ NACK bit values).

As described elsewhere herein, the first WCD 505 may configure one or more communication parameters to achieve a target error rate for a given channel, such as the PDSCH. The second WCD 510 may transmit, and the first WCD 505 may receive, a codebook indicating feedback (e.g., HARQ ACK/NACK feedback) for the given channel. Because the communication parameter(s) are configured to achieve the target error rate (e.g., target BLER) for the given channel, the feedback information for the given channel will be biased and/or non-uniform. For example, if the target BLER for the PDSCH is 10%, then the probability that feedback is ACK feedback is 90% for a given communication (e.g., a given transport block) transmitted via the PDSCH. In some examples, codebooks may be designed for uniform probability of messages with equal likelihood of the bit 0 and bit 1. In such examples, power is applied uniformly to all codewords in the codebook. For example, each codeword may be transmitted using the same transmit power. This results in inefficient power usage by the network entity transmitting the codebook.

In some examples, a network entity may utilize techniques for power shaping associated with non-uniform message transmissions to improve power savings. For example, more power may be proportionally assigned to less likely symbols (e.g., less likely codewords) and less power to more likely symbols (e.g., more likely codewords) to reduce the average transmit power and improve error performance. For example, the network entity may scale a power of a codeword based on, or otherwise associated with, a probability associated with the codeword. As an example, the network entity (e.g., the second WCD 510) may perform a power scaling procedure for the codeword c(x^{k}) based on a power scaling parameter. In some examples, the second WCD 510 may receive the power scaling parameter from the first WCD 505. In some examples, the power scaling parameter may be associated with a non-uniform probability of respective portions of the message x^{k}. For example, the power scaling procedure may use a scaling parameter of

$$log ( \frac{1}{p ( {x}^{k} )} ) ,$$

where p(x^{k}) is the non-uniform probability of the message x^{k}. The message x^{k} may include one or more feedback indications, such as HARQ-ACK indications or HARQ NACK indications, among other examples. In other words, if a codeword c has probability π_{c}, then the transmit power allocated to that codeword may be proportional to the probability associated with the codeword (e.g., P_{c} ∝−log π_{c}, where P_{c} is a power shaping parameter).

In some examples, techniques for power control for ACK/NACK transmission may scale power according to the probability of a message sequence. For example, if the message sequence x^{k} has probability p(x^{k}), then the power of the corresponding codeword transmission c(x^{k}) may be scaled with

$$log ( \frac{1}{p ( {x}^{k} )} ) .$$

After normalization with respect to unit expected power over the whole codebook, message sequence x^{k} may be mapped to

$$\sqrt{log ( \frac{1}{p ( {x}^{k} )} ) * \frac{1}{{\sum }_{{x}^{k}} p ( {x}^{k} ) log ( \frac{1}{p ( {x}^{k} )} )}} * c ( {x}^{k} ) ,$$

where the normalization parameter α is

$$\frac{1}{{\sum }_{{x}^{k}} p ( {x}^{k} ) log ( \frac{1}{p ( {x}^{k} )} )} .$$

Techniques for power control for the message comprising independent and identically distributed bit values may scale power according to the probability of a message sequence. If all bits are independent and identically Bernoulli distributed (Bern(p)), the probability may be p(x^{k})=p^{m}(1−p)^{k-m}, where p denotes a probability of bit 1, m denotes a quantity of bit 1 in the message x^{k}, and k denotes the message length. In some cases, the normalization parameter may be simplified to

$$α = {\sum }_{{x}^{k}} p ( {x}^{k} ) log ( \frac{1}{p ( {x}^{k} )} ) = \frac{1}{k H ( p )} ,$$

where H(p)=−p log (p)−(1−p) log (1−p) is the entropy of Bern(p) variable and may be precomputed for a given value of p. The power scaling may be simplified to

$$α * log ( \frac{1}{p ( {x}^{k} )} ) = \frac{1}{k * H ( p )} log ( \frac{1}{p ( {x}^{k} )} ) .$$

In some examples, techniques for power control for the message comprising bits having non-identically distributed bit values may scale power according to the probability of a message sequence. In some cases, the bits may correspond to different types of contents. For example, a subset of message bits may correspond to HARQ-ACK and another subset may correspond to an SR.

The use of a power shaping operation (e.g., a per-codeword power shaping operation or scheme as described in more detail elsewhere herein) for control channel data (e.g., HARQ information, UCI, SR data, or other control channel data) introduces additional considerations that are not present when only analog power control (e.g., codeword agnostic power control) is used. For example, To ensure reliable channel estimation, one or more network entities may use a TPR. The TPR indicates a ratio between a first transmit power of pilot signals transmitted via a channel and a second transmit power of data (or payload) signals transmitted via the channel (e.g., a ratio between the power allocated to data traffic and the power allocated to the pilot signals for a given channel). The TPR may impact channel estimation accuracy, beamforming performance, spectral efficiency, interference mitigation, and/or dynamic resource allocation, among other examples. In examples where a codebook uses uniform power for all codewords, the TPR may be a static value. For example, the TPR may be based on a quantity of CDM groups per resource element in a pilot signal (e.g., a DMRS) as compared to a quantity of CDM groups per resource element in data traffic. As an example, for a PUCCH, where the pilot signal (e.g., the DMRS) and data traffic both have the rank 1, the TPR may be 0 dB. However, where power scaling or power shaping is applied to vary the transmit power for codewords in a codebook (e.g., based on the nonuniform probabilities of respective codewords), the TPR may vary over time based on the power scaling or power shaping being applied. As a result, network entities that are communicating may be unaware of a TPR for a given channel at a given time. The varying TPR (e.g., that may have a value different than 0 dB) may negatively impact the performance of channel estimation accuracy, beamforming performance, spectral efficiency, interference mitigation, and/or dynamic resource allocation, among other examples.

As another example, a network node may use performance parameters (e.g., KPIs) that are associated with (or specific to) control channel data that is associated with the power shaping operation. For example, a performance parameter may include a UEP parameter. Different issues may arise from errors in decoding ACK or NACK bits. Erroneously decoding an ACK as a NACK would only result in increasing overhead owing to retransmission. However, erroneously decoding a NACK as an ACK would lead to an unrecoverable decoding error for the communication associated with the HARQ feedback. Accordingly, UEP to prioritize correctly decoding NACKs over correctly decoding ACKs may be desirable for increasing network reliability and decreasing network latency. “Unequal error protection” or “UEP” refers to enforcing or targeting different error rates for different types of bits to protect some bits more than others. In some examples, it may be desirable to achieve UEP with a first BER for decoding NACK bits (e.g., BER_{NACK}=0.1%) that is lower than a second BER for decoding ACK bits (e.g., BER_{ACK}=1%) in order to prioritize correctly decoding NACKs over correctly decoding ACKs. However, given a digital power shaping operation that applies per-codeword power shaping, existing techniques (e.g., analog power control techniques) cannot be used to achieve UEP for control channel data (e.g., that is encoded using a codebook for which per-codeword power shaping is applied).

As indicated above, FIG. 5 is provided as an example. Other examples may differ from what is described with regard to FIG. 5.

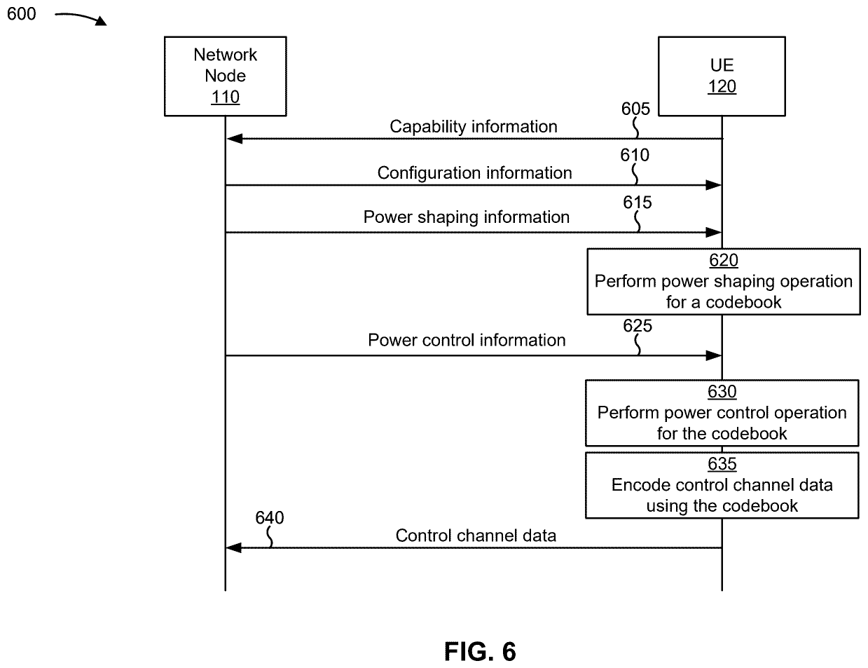

FIG. 6 is a diagram of an example 600 associated with a power control framework, in accordance with the present disclosure. As shown in FIG. 6, a network node 110 (e.g., a wireless node, a base station, a CU, a DU, and/or an RU) May communicate with a UE 120. In some aspects, the network node 110 and the UE 120 may be part of a wireless communication network (e.g., the wireless communication network 100). The UE 120 and the network node 110 may have established a wireless connection prior to operations shown in FIG. 6.

Although some examples are described herein in connection with uplink control channel communications, the techniques described herein (such is in connection with FIGS. 6-13) may be similarly applied to other types of communications that use codebook-based communication (e.g., sidelink communications, downlink communications, peer-to-peer communications, machine-type communications, or other types of communications).

In some aspects, at 605, the UE 120 may transmit (e.g., output for transmission) capability information. The network node 110 may receive (e.g., obtain) the capability information. The capability information may be included in a capability report. The UE may transmit the capability information via an uplink communication, a sidelink communication, a unicast communication, a broadcast communication, a UE assistance information (UAI) communication, an UCI communication, an SCI communication, a MAC-CE communication, an RRC communication, a PUCCH, a PUSCH, a PSCCH, and/or a PSSCH, among other examples. The capability information may indicate one or more parameters associated with respective capabilities of the UE. The one or more parameters may be indicated via respective information elements (IEs) included in a capability report.

The capability information may indicate whether the UE 120 supports a feature and/or one or more parameters related to the feature. For example, the capability information may indicate a capability and/or parameter for the power control framework for a control channel (e.g., the PUCCH), as described herein. As another example, the capability information may indicate a capability and/or parameter for supporting a per-codeword power shaping codebook for the channel. One or more operations described herein may be based on capability information. For example, the UE may perform a communication in accordance with the capability information, or may receive configuration information that is in accordance with the capability information. The capability information may indicate UE support for one or more (e.g., any) operations (e.g., performed by the UE 120) described herein.

In some aspects, the capability information may indicate UE support for using a model to determine (or predict) the data distribution (e.g., probability distribution) for a control channel (e.g., a probability distribution of codewords included in a codebook associated with the control channel). The capability information may indicate UE support for outputting for transmission one or more model parameters that are indicative of the data distribution for the control channel. In some aspects, the capability information may indicate UE support for scenario-specific (e.g., data-distribution-specific) encoding schemes associated with the control channel. For example, the capability information may indicate UE support for modifying or determining a power shaping scheme (e.g., for calculating one or more power shaping parameters for respective codewords) using the model and/or the one or more model parameters.

In some aspects, the capability information may indicate UE support for scaling or modifying the per-codeword power shaping codebook based on, or otherwise associated with, an average TPR for the channel. In some aspects, the capability information may indicate UE support for a step gap-based power shaping scheme. For example, the capability information may indicate whether the UE 120 supports being configured with, or receiving an indication of, a step gap for a power shaping scheme, as described in more detail elsewhere herein.

In some aspects, the network node 110 may determine or configure a power control framework based on, or otherwise associated with, the capability information. For example, the network node 110 may transmit (e.g., at 615 and/or at 625) information for a power shaping scheme or a power control scheme that is in accordance with the capability information (e.g., that is indicated in the capability information as being supported by the UE 120). In other aspects, the network node 110 may determine or configure a power control framework without, or independent of, the capability information.

At 610, the network node 110 may transmit (e.g., output for transmission), and the UE 120 may receive (e.g., obtain), configuration information. In some aspects, the UE 120 may receive the configuration information via one or more of system information signaling (e.g., a master information block (MIB) and/or a system information block (SIB), among other examples), RRC signaling, MAC signaling (e.g., one or more MAC-CEs), and/or physical layer signaling (e.g., DCI), among other examples.

In some aspects, the configuration information may indicate one or more candidate configurations and/or communication parameters (e.g., scenario-specific encoding and/or decoding or default encoding and/or decoding for the control channel). In some aspects, the one or more candidate configurations and/or communication parameters may be selected, activated, and/or deactivated by a subsequent indication (e.g., such as described at 615 and/or at 625). For example, the subsequent indication may select a candidate configuration and/or communication parameter from the one or more candidate configurations and/or communication parameters. In some aspects, the subsequent indication (e.g., an indication described herein, such as at 615 and/or at 625) may include a dynamic indication, such as one or more MAC-CEs and/or one or more DCI messages, among other examples.

The configuration information may indicate that the UE 120 is to output (e.g., transmit) an indication of one or more model parameters for a data distribution model. The one or more model parameters may be indicative of a data distribution (e.g., a probability distribution) for a control channel (e.g., for an uplink control channel). The data distribution may include a relative frequency associated with one or more codewords in the codebook over a time interval (e.g., where the time interval is between RRC reconfigurations associated with the model and/or between switches between models, as described in more detail elsewhere herein). The model may include an autoregressive model, a transformer, or another model configured to output an inference or prediction of a probability of occurrence for one or more codewords. In some aspects, the configuration information may indicate the model to be used by the UE 120. In other aspects, the model to be used by the UE 120 may be defined, or otherwise fixed, by a wireless communication standard, such as the 3GPP.

In some aspects, the configuration information may indicate that the UE 120 is to communicate (e.g., transmit) uplink control channel communications using the per-codeword power shaping codebook. For example, the configuration information may include a configuration for the uplink control channel (e.g., a PUCCH configuration). The configuration information may configure one or more uplink control channel (e.g., PUCCH) rate tuples rᵢ=(kᵢ, nᵢ), where kᵢ is a quantity of information bits, and nᵢ is the quantity of resources allocated for PUCCH transmission (e.g., quantity of frequency domain resources (e.g., subcarriers, resource blocks, and/or resource elements)) and/or quantity of time domain resources (e.g., symbols).

For each PUCCH rate tuple, the configuration information may indicate a codebook. The codebook may be a per-codeword power shaping codebook. In other words, the codebook may be associated with power shaping parameters for respective codewords included in the codebook (e.g., each codeword may have a separate or dedicated power shaping parameter to define a power to be allocated to that codeword). For example, the codebook may be represented as [symbol] ᵢ=[\sqrt{P_{i,1}c_{i,1}}, . . . P_{i,2}kG_{1,2}kᵢ], where P_{i,j} represents the power shaping parameter for the codebook i and the codeword j, and c_{i,j} represents the codeword j for the codebook i, where the codebook i includes 2^{k} codewords (e.g., where k is the quantity of information bits for the codebook i). [symbol] ᵢ may also be referred to herein as an encoder. For example, the encoder may include a codebook [c_{i,1}) . . . , c_{i,2}kᵢ] and a power shaping scheme that includes one or more power shaping parameters [P_{i,1}, . . . , P_{i,2}k].

As described elsewhere herein, a value of a power shaping parameter (e.g., P_{i,j}) may be configured or determined based on, or otherwise associated with, a probability of a corresponding codeword being included in a PUCCH communication. For example, the UE 120 may transmit the codebook i via one or more uplink control channel communications (e.g., in PUCCH data). The PUCCH data may include M unique codewords from the codebook i, where M≤Σᵢ2^{k}^{ᵢ}.

In some aspects, the configuration information may indicate a step gap for the power shaping scheme (e.g., for a power shaping operation performed at 620). For example, a power vector for per-codeword-based power shaping may be a two-level vector (e.g., may include two discrete power levels) [P_{i,1}, . . . , P_{i,2}k], where a first power level is P_{i,2}k and all other power levels (e.g., indicated by power shaping parameters) are equal to a second power level. For example, the first power level may be a minimum power level and the second power level may be a maximum power level. The step gap may indicate a difference between the first power level and the second power level. In some aspects, the first power level may be applicable for a given message sequence (e.g., a given codeword) and the second power level may be applicable for all other message sequences (e.g., all other codewords). For example, the first power level may be applicable for a codeword includes all ACK indications.

In other examples, the power vector may include more than two power levels. In such examples, the step gap may indicate a spacing or difference (e.g., an equal spacing or equal difference) between power levels. For example, the power vector may include a first power level, a second power level, and a third power level. The step gap may indicate a difference between the first power level and the second power level, and the difference between the second power level and the third power level.

The UE 120 may configure itself based at least in part on the configuration information. In some aspects, the UE 120 may be configured to perform one or more operations described herein based at least in part on the configuration information.

At 615, the network node 110 may transmit, and the UE 120 may receive, power shaping information (e.g., information for a power shaping operation, such as the power shaping operation performed at 620). The power shaping information may be communicated via RRC signaling, MAC signaling, and/or DCI signaling, among other examples. For example, the network node 110 may output for transmission, and the UE 120 may obtain, one or more RRC configuration communications that include the indication that scenario-specific encoding and/or decoding is to be used for the control channel. For example, an RRC configuration communication may include information (e.g., a parameter or IE) indicating that the model is to be used to indicate the data distribution for the control channel.

In some aspects, the power shaping information may indicate a model or power shaping scheme to be applied by the UE 120 (e.g., an encoder to be used to encode control channel data). For example, at 615, the network node 110 may transmit, and the UE 120 may receive, an indication to obtain one or more model parameters. For example, the power shaping information may indicate that the UE 120 is to update or modify an encoding scheme used for the control channel. For example, the UE 120 receiving the power shaping information may cause or trigger the UE 120 to determine (e.g., calculate) one or more model parameters for the model. The indication to obtain one or more model parameters may be communicated via RRC signaling, MAC signaling, and/or DCI signaling, among other examples. For example, the network node 110 may transmit, and the UE 120 may receive, one or more RRC configuration communications that include the indication to obtain one or more model parameters. As an example, the indication to obtain one or more model parameters may be included in an RRC reconfiguration (e.g., RRCReconfiguration) communication. For example, the RRC reconfiguration communication may include information (e.g., a parameter or IE) indicating that the UE 120 is to update the encoding scheme used for the control channel and/or indicating that the UE 120 is to output or transmit an indication of the one or more model parameters.

For example, the network node 110 may transmit, and the UE 120 may receive, a first communication indicating that the model is enabled for use. The UE 120 receiving the first communication may cause the UE 120 to begin tracking a data distribution (e.g., a probability distribution of codewords) associated with the control channel. Additionally, or alternatively, the network node 110 may transmit, and the UE 120 may receive, a second communication indicating that the model is to be reconfigured for the control channel. The UE 120 receiving the second communication may cause the UE 120 to determine and/or output for transmission (e.g., transmit) the one or more model parameters, as described herein.

In some aspects, the power shaping information may include or indicate the step gap described elsewhere herein. The UE 120 may use the step gap to initialize and/or determine a codeword power vector (e.g., that includes power levels for respective codewords) based on, using, or otherwise associated with the step gap. In some aspects, the power shaping information may indicate a prior associated with the codebook. The prior may be associated with the codebook in that the prior is indicative of a probability distribution for the codebook (e.g., an ACK/NACK probability distribution). For example, the prior may be a prior probability distribution for the codebook. The prior may be indicative of the step gap. For example, the UE 120 may use the prior to determine or select the step gap. As an example, the UE 120 may store a data structure (e.g., a lookup table or another data structure) that indicates mappings between priors and step gaps. The UE 120 may perform a lookup operation using the prior and the data structure to determine the step gap. The UE 120 may use the step gap to initialize or obtain the codeword power vector for the codebook.

In some aspects, the power shaping information may indicate a codeword power vector (e.g., that includes power levels for respective codewords included in the codebook). In other examples, the UE 120 may determine or obtain the codeword power vector using the power shaping information. For example, the UE 120 may determine or obtain the codeword power vector using step gap (e.g., as the step gap may be indicative of two distinct power levels included in the codeword power vector).

At 620, the UE 120 may perform the power shaping operation in accordance with the power shaping information. For example, the UE 120 may perform the power shaping operation in accordance with the power shaping information in that the UE 120 performs the power shaping operation based on, after, in response to, or otherwise associated with receiving the power shaping information. As another example, the UE 120 may perform the power shaping operation in accordance with the power shaping information in that the UE 120 performs the power shaping operation using one or more parameters (e.g., a step gap, a model, a codebook, or other information) indicated by the power shaping information.

For example, the power shaping operation at 620 may include the UE 120 tracking, maintaining, and/or storing an indication of the data (e.g., historical data or previously transmitted data) included in the one or more control channel communications. For example, the data (e.g., historical data or previously transmitted data) may be used by the UE 120 to determine one or more model parameters of the model, as described elsewhere herein.

The UE 120 may configure itself, based at least in part on, or after, receiving (e.g., obtaining) the power shaping information at 615 to use the model to determine or indicate the data distribution for the control channel. For example, the UE 120 may configure itself to track, maintain, and/or store an indication of the data (e.g., historical data or previously transmitted data) included in the one or more control channel communications.

As part of the power shaping operation at 620, the UE 120 may determine the one or more model parameters. The UE 120 may determine the one or more model parameters using the model. The one or more model parameters may be associated with a data distribution of the control channel over a time interval. For example, the data distribution includes a relative frequency (e.g., frequency of transmission) associated with one or more codewords in the codebook over the time interval. The time interval may be an amount of time between reconfigurations and/or switches associated with the encoding and decoding scheme for the control channel. As another example, the time interval may be an amount of time between reconfigurations and/or switches associated with the model (or multiple models including the model). For example, the time interval may be a time interval between the model being configured for use and a reconfiguration of the model. As another example, the time interval may be a time interval between a first reconfiguration of the model and a second reconfiguration of the model (e.g., RRC reconfigurations and/or MAC-CE initiated model switches).

In some aspects, the codewords included in the one or more control channel communications may have the same size (e.g., the same payload length). In other aspects, the codewords included in the one or more control channel communications may have different sizes (e.g., different payload lengths). In examples where the codewords have the same size, a first type of model may be used by the UE 120. In examples where the codewords have different sizes, a second type of model may be used by the UE 120. For example, the first type of model may be an autoregressive model (e.g., which may have reduced processing overhead and/or signaling overhead as compared to other types of models). For example, an assumption of the first type of model may include the size of the codeword being the same for each codeword. The second type of model may be a transformer (e.g., which may be associated with improved flexibility and/or performance for codewords having different sizes).

In some aspects, the UE 120 may train the model using the data distribution (e.g., of the control channel) over the time interval. For example, the UE 120 may train or estimate (e.g., fit) one or more model parameters of the model using the data distribution. For example, the UE 120 may determine best possible values of respective model parameters to improve the inference performance of the model. The inference performance may be associated with an accuracy of a prediction of a next data value (e.g., a next HARQ-ACK data value) in a series of uplink control channel data. The one or more model parameters may include an order parameter (e.g., indicating an order of the model), one or more coefficients (e.g., having respective weights), an error variance, one or more coefficient parameters (e.g., indicating a correlation between a current observation and one or more previous or lagged values), an embedding dimension, a quantity of attention heads, a feed-forward network dimension, and/or a classification token, among other examples.

For example, the model may include an autoregressive model. An order of the autoregressive model may be one, two, or another value. The UE 120 may determine the data distribution or probability distribution for one or more codewords included in a given codebook (e.g., for the time interval described above). For example, the UE 120 may set a probability for any codewords that were not included in any of the control channel communications during the time interval to zero. The data distribution may include probabilities for respective codewords included in the codebook. For example, the data distribution may be Π=[π₁, . . . , π_{M}], where Π is the data distribution, where there are M codewords included in the codebook, and where πᵢ; is the probability of occurrence for an i^{th} codeword included in the codebook. The UE 120 may train or estimate (e.g., fit) the model to the data distribution (e.g., Π). The model parameter(s) of the model that is fit to the data distribution may be the one or more model parameters. As another example, the UE 120 may receive (e.g., obtain or download) the model (e.g., an encoder) via a server or another device. In such examples, the network node 110 may receive (e.g., obtain or download) a corresponding model (e.g., a decoder) via the server or another device.

For example, the autoregressive model may be a time series model where a current value (e.g., a codeword) is predicted based on past values (e.g., past values of codewords). Fitting an autoregressive model to data may include the UE 120 estimating coefficients of the autoregressive model. The coefficients may represent the influence of past observations on a current observation. The one or more model parameters may include the coefficient(s) of the autoregressive model. The UE 120 may estimate the coefficient(s) using ordinary least squares (OLS) regression, and/or or maximum likelihood estimation (MLE), among other examples.

In some aspects, the autoregressive model may have an order of one. In such examples, the one or more model parameters may include a message type probability (e.g., an ACK probability) and a coefficient parameter. The ACK probability may be a fixed value (e.g., based on the BLER for the downlink data channel (e.g., the PDSCH)). The coefficient parameter may indicate a strength or relation (e.g., an impact) of a previous observation (e.g., a previous information bit) on a current observation (e.g., a current information bit). For example, a conditional probability of a current bit being an ACK value when a previous bit was an ACK value may be p+ρ(1—p), where p is the ACK probability and p is the coefficient parameter. Similarly, the conditional probability of a current bit being a NACK value when a previous bit was an NACK value may be (1−p)+pp. Using the above assumptions, the UE 120 may determine a probability of occurrence for k bits included in a control channel message. For example, for an autoregressive model having an order of one, the UE 120 may fit the model as

$$π ( {b}_{0} , … {b}_{k - 1} ) = p ( {b}_{0} ) {\prod }_{i = 1}^{k - 1} P ( {b}_{i} \vert {b}_{i - 1} ) ,$$

where the total quantity of data bits in an uplink control channel communication is k, where bᵢ is the i^{th} bit in the uplink control channel communication, and where P(bᵢ|bᵢ₋₁) is the probability of the i^{th} bit conditioned on a value of the previous bit. In such examples, the one or more model parameters may include the ACK probability (e.g., p) and the coefficient parameter (e.g., p).

As another example, for an autoregressive model having an order of two, the one or more model parameters may include two coefficient parameters, a first coefficient parameter (e.g., ρ₁) for a first previous bit and a second coefficient parameter (e.g., ρ₂) for a second previous bit that is previous to the previous bit. In such examples, the probability of a current bit and the two previous bits being ACK values may be p+ρ₂(1−p), a probability of a current bit being an ACK value, the previous bit being an ACK value, and the second previous bit being a NACK value may be p+ρ₁(1−p). Additionally, the probability of each of the three bits being NACK values may be (1−p)+ρ₂p, and a probability of the current bit and the first previous bit being NACK values and the second previous bit being an ACK value may be (1−p)+ρ₁p. Using the above assumptions, the UE 120 may determine the probabilities for a set of k bits (e.g., π(b₀, . . . bₖ₋₁)) the equation

$$π ( {b}_{0} , … {b}_{k - 1} ) = p ( {b}_{0} ) p ( {b}_{1} \vert {b}_{0} ) {\prod }_{i = 2}^{k - 1} P ( {b}_{i} \vert {b}_{i - 1} , {b}_{i - 2} ) .$$

In such examples, the one or more model parameters may include the ACK probability (e.g., p), the first coefficient parameter (e.g., ρ₁), and the second coefficient parameter (e.g., ρ₂).

As another example, the UE 120 may use a transformer to estimate the probabilities for a set of k bits (e.g., π(b₀, . . . bₖ₋₁)). The transformer may include, or may be, a neural network. Without assuming a value of k, the probabilities for a set of k bits may be

$$π ( {b}_{0} , … {b}_{k - 1} ) = p ( {b}_{0} ) {\prod }_{i = 1}^{k - 1} P ( {b}_{i} \vert {b}_{i - 1} , … {b}_{0} ) .$$

The UE 120 may train the transformer using an autoregressive operation (e.g., using the data distribution (e.g., Π)) to train the transformer to predict a value of a next bit in a sequence of bits. For example, the UE 120 may train the transformer using a ground truth target sequence (e.g., the data distribution Π) and can use one or more training operation to set one or more weights or architectures of the transformer to accurately predict a value of a next bit in a sequence of bits for the control channel. The transformer may enable the UE 120 to predict the probability for any size or sequence length of a codeword. If a transformer is used, the one or more model parameters may include one or more weights of layers (e.g., neural network layers) of the transformer, and/or one or more architecture parameters of the transformer (e.g., a quantity of layers), among other examples.

After determining or receiving the one or more model parameters, the UE 120 may reset the data distribution for the control channel. For example, the UE 120 may set the values included in the data distribution Π to zero. In other words, the UE 120 may, after determining and/or transmitting (e.g., as part of the power shaping operation at 620) the one or more model parameters, reset the relative frequencies of respective codewords to zero. This enables the UE 120 to track and/or maintain a more accurate and/or recent data distribution of the control channel. For example, by resetting the relative frequencies of respective codewords to zero, the UE 120 may reduce the likelihood of older data transmitted via the control channel impacting the determination of future model parameter(s).

As part of the power shaping operation at 620, the UE 120 may transmit, and the network node 110 may receive, an indication of the one or more model parameters. The UE 120 may transmit the one or more model parameters using RRC signaling, MAC signaling, and/or UCI signaling. For example, the UE 120 may transmit the one or more model parameters via one or more MAC-CEs. In some examples, the UE 120 may transmit the one or more model parameters via the control channel (e.g., via a PUCCH transmission). Alternatively, the UE 120 may transmit the one or more model parameters via a data channel or a shared channel (e.g., via a PUSCH transmission). As described above, the UE 120 may reset the data distribution for the control channel after outputting the one or more model parameters.

As part of the power shaping operation at 620, the UE 120 may determine power shaping parameters for the codebook in a similar manner as described elsewhere herein, such as in connection with FIG. 5. For example, for a rate tuple r=(k, n) and a codebook prior Π₀, the UE 120 may determine or obtain (e.g., initialize) a codebook [symbol] =[\sqrt{P₁c₁}, . . . , \sqrt{P₂kc₂k}], where Pⱼ represents the power shaping parameter for the codebook and the codeword j, and c; represents the codeword j for the codebook, where the codebook includes 2^{k} codewords (e.g., where k is the quantity of information bits for the codebook). Additionally, the UE 120 may determine or obtain a codeword power vector P=[P₁, . . . , P₂k], where Pⱼ represents the power shaping parameter for the codebook and the codeword j. As used herein, a variable being represented in bold text may indicate that the variable is a vector.

In some examples, the codebook [symbol] may be a nonlinear codebook. For example, the codebook [symbol] may be designed using one or more deep learning techniques. For example, the codebook [symbol] may be designed by fixing the power shaping scheme to a step power shaping scheme with a given step gap, thereby enabling the UE 120 and/or the network node 110 to determine the codeword power vector P=[P₁, . . . , P₂k]. Additionally, given a step gap, the UE 120, the network node 110, and/or another device (e.g., a server) may train a model (e.g., a transformer) over a range of autoregressive models (e.g., over a range of values for ACK probability (e.g., p) and values for the coefficient parameter (e.g., p)). An output of the model (e.g., the transformer) May indicate the codewords (e.g., [c₁, . . . , c₂k]). This may include optimizing the weights of the transformer (e.g., optimizing the weights of a neural network) to minimize the probability of an error for a given decoder. For example, the codebook may be designed by utilizing the transformer to encode the message sequences b. Gaussian noise may be added to the encoded sequence c to generate the received signal y. The received signal y may be decoded using a bitwise maximum a posteriori (MAP) decoder, thus obtaining P(bᵢ|y). The transformer may be trained to maximize Σ_{i∈[k]}(1−tᵢ)p(bᵢ=0|y)+tᵢp(bᵢ=1|y) where tᵢ=1 if bᵢ=1 else 0. This may enable the codebook to be designed to reduce the likelihood of decoding errors at the network node 110, thereby improving performance of control channel data transmissions.

An average power of the codebook [symbol] may be based on a summation of the power of each codeword multiplied by the probability of each codeword being included in a given transmission. For example, the average power may be represented as [symbol] _{Π}P=10 log₁₀P^{T}Π, where [symbol] _{Π} is the expected value of the current codeword distribution Π, Π is a vector that includes current probabilities of respective codewords included in the codebook, and P^{T} is a transpose of the codeword power vector P. In some examples, to initialize the average power of the codebook, the UE 120 may scale the codeword powers and/or the codeword power vector.

For example, the UE 120 may determine or obtain a scaling factor. The scaling factor may be associated with the average power of the codebook. For example, the scaling factor may be a negative of the average power in the dB domain. As an example, the scaling factor may be represented as γ(Π₀)=− [symbol] Π₀P, where γ(Π₀) is the scaling factor for the codebook prior Π₀. The UE 120 may obtain or determine, using the scaling factor, modified power shaping parameters for respective codewords from the set of codewords included in the codebook. “Power shaping parameter.” “codeword power,” and “codeword power level” may be used interchangeably herein. For example, a power shaping parameter for a codeword may be indicative of the power level for that codeword. The UE 120 may scale all codeword power levels by the scaling factor. As an example, the modified power shaping parameters may be represented as P′=γ(Π₀)×P. By the UE 120 scaling or modifying the codeword power levels (e.g., the codeword power vector) using the scaling factor, the UE 120 may ensure that the codebook power, averaged over the codebook prior (Π₀), has a unit norm (e.g., to initialize the codebook). For example, by the UE 120 scaling or modifying the codeword power levels (e.g., the codeword power vector) using the scaling factor, the UE 120 may improve the likelihood that the average power of the codebook in the dB domain is zero dB when initialized. Because the codebook may include codewords having different power levels, improving the likelihood that the average power of the codebook in the log domain is zero dB when initialized may reduce the complexity for normalization of the codewords included in the codebook and/or reduce the complexity associated with power control operations (e.g., analog power control operations), such as described at 630.

As described in more detail elsewhere herein, the power shaping operation at 620 may at least partially occur in the digital domain (e.g., via a digital baseband of the UE 120). For example, control channel data may be represented as a sequence of binary bits that are mapped (for example, modulated) to an analog signal waveform (for example, a DFT-s-OFDM waveform or a CP-OFDM waveform) that is transmitted by the UE 120 over a wireless communication channel, such as a control channel (e.g., the PUCCH). The power shaping operation at 620 may at least partially be performed by the UE 120 before modulated symbols representing the control channel data are converted to the analog domain. As an example, the UE 120 may obtain a sequence of binary bits representing the control channel data. The UE 120 may perform an encoding operation (e.g., a channel coding operation or an FEC operation) to control errors in transmitted information. For example, the UE 120 may perform an encoding operation to generate encoded information (e.g., coded bits), such as by selectively introducing redundancy into the information, typically using an error correction code (ECC), such as a polar code or a low-density parity-check (LDPC) code. As another example, the UE 120 may perform an encoding operation to generate encoded information (e.g., coded bits) using a transformer or neural network based encoder. The UE 120 may modulate the coded bits in accordance with an MCS (e.g., by mapping the coded bits to modulated symbols). As an example, as part of the power shaping operation at 620, the UE 120 may apply the power shaping parameters (e.g., that are modified by the scaling factor) to the modulated symbols (e.g., before converting the modulated symbols to the analog domain).

The network node 110 may perform a power shaping operation for the codebook in a similar manner as described in connection with the UE 120 at 620. For example, the network node 110 may update a decoding scheme and/or power shaping scheme (e.g., for the control channel) using the one or more model parameters. For example, the network node 110 may determine and/or obtain, by using the one or more model parameters, a prior distribution for a decoder (e.g., a MAP-based decoder). The decoder may be used by the network node 110 to decode data included in control channel communications.

Additionally, or alternatively, the network node 110 may determine (e.g., calculate) values for one or more power shaping parameters using the one or more model parameters. For example, as described elsewhere herein, the encoder is associated with a codebook and a power shaping scheme. For example, the codebook may be a per-codeword power shaping codebook that is associated with power shaping parameters for respective codewords included in the codebook. The values of the power shaping parameters may be based on, or otherwise associated with, the one or more model parameters. In other words, for different model parameters, the network node 110 may determine or use different power shaping parameters. The network node 110 may determine the power shaping parameters in a similar manner as described elsewhere herein, such as in connection with FIG. 5. In some examples, the network node 110 may store a mapping of model parameter(s) to power shaping parameters.

The network node 110 may use the mapping to determine the power shaping parameters for the power shaping scheme. By varying the power shaping parameters for different model parameters, the power shaping scheme may be tailored to the data distribution of the control channel, thereby improving the power efficiency of control channel communications.

At 625, the network node 110 may transmit, and the UE 120 may receive, power control information (e.g., information for a power control operation). The power control information may be communicated via RRC signaling, MAC signaling, and/or DCI signaling, among other examples.

As an example, the network node 110 may transmit, and the UE 120 may receive, the power control information via physical layer signaling. For example, the network node 110 may transmit, and the UE 120 may receive, the power control information via a control communication and/or control information. For example, the network node 110 may transmit the power control information via downlink control information or another type of control information. The control information may be associated with a format or type, such as a DCI type or DCI format. The power control information may be included in a field of the format or type (e.g., a legacy format or legacy type that includes a new or modified field in which the power control information is included). As another example, the format or type may be associated with power control signaling (e.g., may be a format or type that is designed or configured for power control signaling).

In some aspects, the format or type may be a DCI format. In some aspects, the DCI format may be a group-common DCI format. For example, the power control information may be included in a group-common DCI communication. In some aspects, the DCI format may be associated with indicating power control (or power shaping) information. In some aspects, the DCI format may be associated with indicating power control (or power shaping) information for uplink communications. The DCI format may be a DCI format 2-2 (e.g., as defined, or otherwise fixed, by a wireless communication standard, such as the 3GPP) or another group-common DCI format. For example, DCI format 2-2 may be used to signal a TPC command for uplink communications. For example, the DCI may be scrambled by a TPC radio network temporary identifier (RNTI), such as a TPC-PUSCH-RNTI or a TPC-PUCCH-RNTI. The DCI may include TPC fields for respective UEs. In some aspects, the DCI may include power control fields for respective UEs (e.g., including the UE 120). The power control field(s) may include the information that is indicative of the power control information. The power control field(s) may be included in a DCI format 2-2 or another DCI format. The power control field(s) may be only applicable to data included in control channel communications (e.g., the power control field(s) may be applicable to power control for control channel data transmissions, but not for control channel reference signal or pilot transmissions).

In some aspects, a control communication that carries or indicates the power control information may indicate that the power control information is applicable only to control channel data (e.g., and not to control channel reference signal or pilot transmissions, such as DMRS transmissions). For example, the codebook may be associated with HARQ information (e.g., the codebook may be a HARQ feedback codebook). The control communication may indicate that the power control information is applicable only to HARQ information. In some aspects, the control communication may indicate that the power control information is for HARQ-ACK data only (e.g., and not to other types of control channel data). For example, the control communication may use a format (e.g., a DCI format) or a field to indicate the power control information that is indicative of the power control information being applicable only to the control channel data (e.g., to indicate that the power control information is for only the codebook).

Additionally, or alternatively, the network node 110 may transmit, and the UE 120 may receive, one or more RRC communications that include the power control information. For example, an RRC parameter or field (e.g., an RRC information element) may include the information that is indicative of the power control information. The RRC parameter or field may be included in RRC signaling that is specific to power control signaling. Alternatively, the RRC parameter or field may be included in another type of RRC signal or communication.

The power control information may include a TPC to modify or adjust a control channel power (e.g., in the analog domain). For example, the network node 110 may receive one or more control channel communications. The network node 110 may determine that the control channel data does not meet one or more performance parameters. For example, the network node 110 may determine that a failure rate of a CRC for the control channel data (e.g., HARQ data) satisfies a threshold (e.g., such as when a quantity of information bit (k) is greater than or equal to a threshold, such as 11). As another example, the network node 110 may determine that a result of a CRC (e.g., a weak CRC) satisfies a threshold (e.g., if | [symbol] y, c* [symbol] |²τ where y is the received signal, c* is the decoding result, and t is the threshold), such as when a quantity of information bit (k) is less than or equal to a threshold (e.g., 11).

As another example, the network node 110 may determine that a TPR for the control channel satisfies a TPR threshold. For example, if the TPR for the control channel is non-zero, then the network node 110 may transmit power control information to modify the power level of control channel data (e.g., to improve the likelihood of the TPR for the control channel being closer to zero dB). In such examples, the power control information may indicate that the power control information is applicable only to the control channel data power (e.g., and not control channel pilot (e.g., control channel DMRS) power). Improving the likelihood of the TPR for the control channel being closer to zero dB may improve the performance of channel estimation accuracy, beamforming performance, spectral efficiency, interference mitigation, and/or dynamic resource allocation, among other examples.

The power control information may indicate that the control channel power is to be modified by a given value (e.g., in dBs). As a result, the network node 110 may determine the power control information to improve the likelihood that one or more performance parameters are met (e.g., that a TPR is near or at zero dB, that UEP failure rates satisfy a failure threshold, among other examples).

At 630, the UE 120 may perform the power control operation for the codebook. As described elsewhere herein, the UE 120 may perform the power control operation in the analog domain. For example, after modulated symbols are converted to the analog domain, the UE 120 may perform the power control operation for the RF waveform to be transmitted. For example, the power control operation may be common to all codewords included in the codebook. For example, the UE 120 may adjust or set a gain of one or more gain control components and/or one or more power amplifiers in an RF front end (e.g., in RF circuitry) of the UE 120 such that the transmit power for the control channel meets (e.g., is the same as) a transmit power indicated by the power control information.

The power control operation at 630 may be performed as part of a model reconfiguration (e.g., an encoder and/or decoder reconfiguration) and/or a codebook initialization operation, as described in more detail elsewhere herein. Additionally, or alternatively, the power control operation at 630 may be performed as part of an OLLA operation, such as a HARQ OLLA operation (e.g., for closed loop power control). Additionally, or alternatively, the power control operation at 630 may be performed as part of an offset reduction operation to cause the average TPR for the control channel to be reduced to (or near) zero dB.

As an example, during a model reconfiguration (e.g., an encoder and/or decoder reconfiguration) and/or a codebook initialization operation, the UE 120 may perform at least a portion of the power control operation. For example, the UE 120 may modify the codeword power vector associated with the codebook using a transmit power value that is associated with the codebook and a performance parameter. The transmit power value may be associated with the codebook and the performance parameter in that the transmit power value may be an average transmit power for the codebook that results in the performance parameter being met (e.g., that results in the performance parameter satisfying a threshold). As an example, the performance parameter may be an unequal error protection parameter for HARQ information, as described elsewhere herein. The average transmit power may be based on (e.g., may be a function of) a current or true codeword prior (e.g., Π) and the codebook [symbol] . The UE 120 may obtain the current or true codeword prior (e.g., Π) via an output of an autoregressive model and/or a transformer, as described in more detail elsewhere herein. For example, the current or true codeword prior (e.g., Π) may be indicative of a current probability distribution of codewords for the control channel. For example, for an initial codeword prior (Π₀), the UE 120 may modify (e.g., scale) the codeword power vector (e.g. P or P′) by a power control scaling factor (e.g., β_{req}). For example, the average transmit power for the codebook may be represented as P_{ave,req}(Π₀)=β_{req} (Π₀)+γ(Π₀)+ [symbol] _{Π}_{₀}P=β_{req} (Π₀). If the power control scaling factor is fixed to Breg (Π₀), and the codeword prior changes to Π, then the average power may be represented as Pₐᵥₑ(Π; Π₀)=B_{req}(Π₀)+κ(Π; Π₀), where κ(Π; Π₀)= [symbol] _{Π}P− [symbol] _{Π}_{₀}P.

In some aspects, the UE 120 may determine or obtain the power control scaling factor based on, or otherwise associated with, the current or true codeword prior Π. For example, the UE 120 may receive an indication of the current or true codeword prior Π (e.g., a prior associated with the codebook) and/or may obtain the current or true codeword prior Π via the output of the model (e.g., the autoregressive model and/or the transform). The UE 120 may store a data structure (e.g., a lookup table or another data structure) that indicates a mapping between codeword priors and power control scaling factors. The UE 120 may perform a lookup operation via the data structure and using the current or true codeword prior Π to obtain the power control scaling factor.

As another example, the UE 120 may obtain the transmit power value in association with a source entropy of a control channel associated with the control channel data. For example, the UE 120 may determine or obtain the power control scaling factor by adding an entropy difference (e.g., between an entropy of a source channel and an entropy of a current or reference channel) to a reference power level. For example, an entropy of a channel for a codebook prior Π may be represented as H(Π)=−Σ_{c}π_{c} log π_{c}, where π_{c} is a probability of a codeword c. Given the average transmit power for an initial codeword prior (P_{ave,req}(Π₀)), P_{ave,req}(Π)≈P_{ave,req}(Π₀)+H(Π)−H(Π₀), where H(Π) is the entropy associated with the channel and the codeword prior Π and H (Π₀) is the entropy associated with the channel and the initial codeword prior. The UE 120 may determine or obtain the power control scaling factor (β_{req}(Π₀)) based on, or otherwise associated with, the average transmit power for the current or true codeword prior Π(e.g., P_{ave,req}(Π₀)), as described in more detail elsewhere herein.

The UE 120 may scale or modify the transmit power level (e.g., in the analog domain) based on, using, or otherwise associated with the power control scaling factor (β_{req}(Π₀)). For example, the UE 120 may modify or scale the codeword power vector (e.g., P or P′) by the power control scaling factor (e.g., β_{req}). Additionally, the UE 120 may modify or scale a pilot transmit power (e.g., a DMRS transmit power) by the power control scaling factor (e.g., β_{req}). This may improve the likelihood that the performance parameter(s) for the control channel are met and ensure that the control channel data power and the pilot transmit power are scaled together (e.g., to reduce the chance of the TPR being non-zero).

Additionally, or alternatively, the UE 120 may perform the power control operation at 630 as part of an OLLA operation (e.g., a HARQ outer loop power control operation) and/or offset reduction operation. For example, the power control information received at 625 may be included in a control communication that indicates the UE 120 is to modify the transmit power for control channel data (e.g., HARQ data) and/or for the control channel as a whole. For the OLLA operation (e.g., a HARQ outer loop power control operation), the UE 120 may apply the power control information (e.g., a TPC) to both control channel data power and pilot power (e.g., DMRS power). For an offset reduction operation, the UE 120 may apply the power control information (e.g., a TPC) to only the control channel data power (e.g., to improve the likelihood of the average TPR for the control channel being zero dB).

The network node 110 may perform a power control operation in a similar manner as described in connection with the UE 120 at 630. For example, the network node 110 may determine an expected power level of control channel data and/or pilot signals communicated via control channel transmissions (e.g., based on the power control information in a similar manner as described herein). The network node 110 may set or configure one or more signal processing components based on the expected power level of control channel data and/or pilot signals communicated via control channel transmissions. For example, the network node 110 may set or configure one or more signal processing components for channel estimation and/or gain control.

The UE 120 performing the power control operation at 630 may information cause one or more transmit power parameters of control channel data to meet one or more performance parameters. As described elsewhere herein, the one or more performance parameters may be associated with the power shaping operation at 620. The one or more performance parameters may be associated with the power shaping operation at 620 in that the one or more performance parameters may be indicative of properties of the control channel data may be impacted or modified as a result of performing the power shaping operation at 620. For example, the one or more performance parameters may include an average TPR for the control channel and/or a UEP parameter for HARQ information, as described in more detail elsewhere herein. For example, by the UE 120 performing the power control operation at 630, a likelihood of the average TPR for the control channel being zero dB may be increased. Additionally, or alternatively, by the UE 120 performing the power control operation at 630, a likelihood of different error rates for ACK and NACK information satisfying respective error thresholds (e.g., 1% for ACK and 0.1% for NACK) as indicated or defined by the UEP parameter.

At 635, the UE 120 may encode control channel data using the codebook and in accordance with the power shaping operation at 620 and in accordance with the power control operation at 630. The encoding of the control channel data may be in accordance with the power shaping operation at 620 in that the UE 120 may use power shaping parameters (e.g., a codeword power vector (e.g. P or P′)) to set power levels for respective codewords included in the codebook (e.g., in the digital domain). The encoding of the control channel data may be in accordance with the power control operation at 630 in that the UE 120 may use a power level adjust or scaling factor (e.g., the power control scaling factor) to adjust a transmit power that is applicable to all codewords included in the codebook (e.g., in the analog domain).

At 640, the UE 120 may transmit, and the network node 110 may receive, the control channel data (e.g., that is encoded using the codebook at 635). For example, the UE 120 may transmit one or more control channel transmissions (e.g., PUCCH transmissions) that include the control channel data. The one or more control channel transmissions may include one or more pilot signals (e.g., one or more DMRSs), as described in more detail elsewhere herein.

As indicated above, FIG. 6 is provided as an example. Other examples may differ from what is described with regard to FIG. 6.

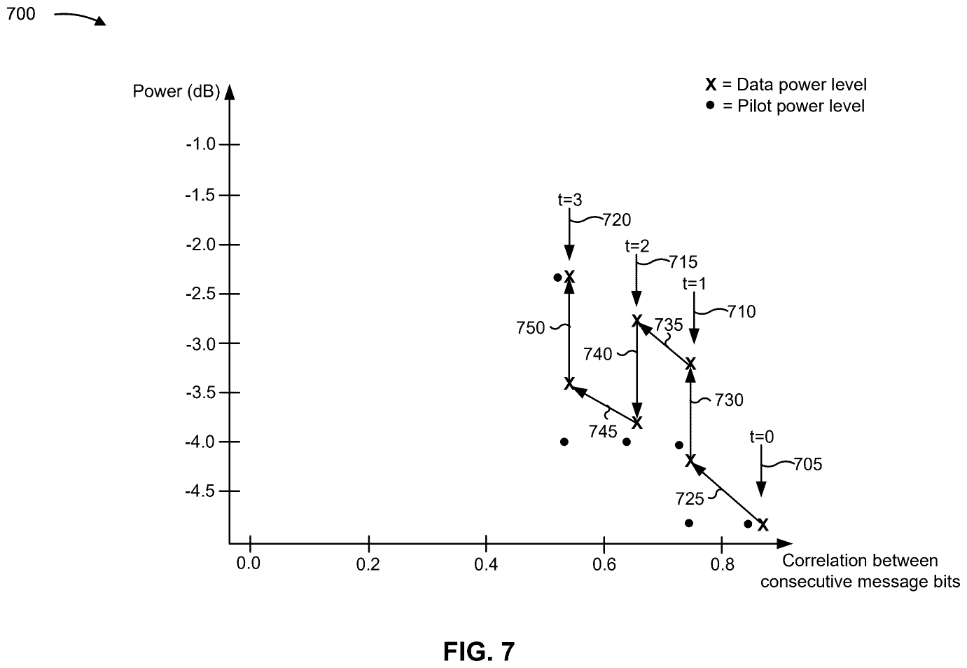

FIG. 7 is a diagram of an example 700 associated with a power control framework, in accordance with the present disclosure. FIG. 7 depicts a graph showing power level changes over time in accordance with the power control framework (e.g., that occur based on performing one or more operations, such as described in connection with FIG. 6). For example, the graph shown in FIG. 7 includes a vertical axis representing power levels in dBs and a horizontal axis representing a correlation between consecutive message bits (e.g., p for an autoregressive model used to obtain a probability distribution for codewords included in a codebook, as described in more detail elsewhere herein, such as in connection with FIG. 6).

As shown in FIG. 7, the graph depicts power levels for control channel data (e.g., data power levels) and for pilot signals (e.g., pilot power levels) at different times. The pilot signals may be DMRSs or another pilot signal. The times are shown as a first time 705 (e.g., t=0), a second time 710 (e.g., t=1), a third time 715 (e.g., t=2) and a fourth time 720 (e.g., t=3). The different times may not be equally spaced over time. For example, a difference between the first time 705 and the second time 710 may not be the same as the difference between the third time 715 and the fourth time 720. Rather, the different times depict example instances in which power levels for the control channel are updated or modified in accordance with the power control framework described herein.

At the first time 705, the UE 120 may perform a model reconfiguration (e.g., for an encoder or model used to obtain a probability distribution for codewords included in a codebook, as described in more detail elsewhere herein) and/or codebook initialization. The UE 120 may perform a power shaping operation (such as the power shaping operation at 620) and a power control operation (such as the power control operation at 630) at the first time 705. At the first time 705, the UE 120 and the network node 110 may estimate the initial coefficient parameter value and initialize the codebook (e.g., and determine a codeword power vector (e.g. P or P′) for the codebook), such as described in connection with the power shaping operation at 620. Additionally, the UE 120 and the network node 110 may scale the codeword power vector and the pilot power level for the control channel by a power control scaling factor (e.g., (β_{req})), such as described in connection with the power control operation at 630.

At the second time 710, the value of the coefficient parameter may have changed. Because the codeword power vector (e.g. P or P′) may be constant between the first time 705 and the second time 710, the average power for the control channel data may increase as shown at 725 (e.g., by κ(Π; Π₀), where Π is the codeword prior at the second time 710 and where Π₀ is the codeword prior at the first time 705, based on the equation Pₐᵥₑ(Π; Π₀)=β_{req}(Π₀)+κ(Π; Π₀) described in more detail in connection with FIG. 6). Before the second time 710, the network node 110 may determine that one or more performance parameters are not being met, such as an UEP parameter, as described in more detail in connection with FIG. 6. Therefore, the network node 110 may transmit, and the UE 120 may receive, power control information indicating that the UE 120 is to modify a transmit power for the control channel (such as described at 625). The power control information may indicate that both the data power level and the pilot level are to be modified (e.g., increased, as shown in FIG. 7). For example, as shown at 730, the transmit power level for the control channel data (and the pilot signal(s)) may be increased by an amount indicated by the power control information. The increase in the transmit power level for the control channel data (and the pilot signal(s)) may be part of an OLLA operation (e.g., a power control operation at 630).

At the third time 715, the value of the coefficient parameter may have changed. Because the codeword power vector (e.g. P or P′) may be constant between the second time 710 and the third time 715, the average power for the control channel data may increase as shown at 735 (e.g., by κ(Π; Π₀), where Π is the codeword prior at the third time 715 and where Π₀ is the codeword prior at the second time 710, based on the equation Pₐᵥₑ(Π; Π₀)=β_{req}(Π₀)+κ(Π; Π₀) described in more detail in connection with FIG. 6). Because the control channel data and the pilot signal(s) have different transmit power levels, a TPR for the control channel may be non-zero (such as at times between the second time 710 and the third time 715). Therefore, the network node 110 may transmit, and the UE 120 may receive, power control information indicating that the UE 120 is to modify a transmit power for the control channel (such as described at 625). The power control information may indicate that only the power level of the control channel data is to be modified or updated. For example, the power control information may be an offset reduction to cause the average TPR of the control channel to be at (or closer to) zero dB. For example, as shown at 740, the transmit power level for the control channel data may be decreased by an amount indicated by the power control information. The decrease in the transmit power level for the control channel data (and the pilot signal(s)) may be part of an offset reduction operation (e.g., a power control operation at 630).

At the fourth time 720, the value of the coefficient parameter may have changed. Because the codeword power vector (e.g. P or P′) may be constant between the third time 715 and the fourth time 720, the average power for the control channel data may increase as shown at 745 (e.g., by κ(Π; Π₀), where Π is the codeword prior at the fourth time 720 and where Π₀ is the codeword prior at the third time 715, based on the equation Pₐᵥₑ(Π; Π₀)=β_{req}(Π₀)+κ(Π; Π₀) described in more detail in connection with FIG. 6). At (or before) the fourth time 720, the UE 120 may perform a model reconfiguration (e.g., for an encoder or model used to obtain a probability distribution for codewords included in a codebook, as described in more detail elsewhere herein) and/or codebook initialization. The UE 120 may perform a power shaping operation (such as the power shaping operation at 620) and a power control operation (such as the power control operation at 630) at (or before) the fourth time 720. At (or before) the fourth time 720, the UE 120 and the network node 110 may estimate the initial coefficient parameter value and initialize the codebook (e.g., and determine a codeword power vector (e.g. P or P′) for the codebook), such as described in connection with the power shaping operation at 620. Additionally, the UE 120 and the network node 110 may scale the codeword power vector and the pilot power level for the control channel by a power control scaling factor (e.g., (Breg)), such as described in connection with the power control operation at 630. This may result in the modification of the control channel data transmit power level and the pilot signal transmit power level as shown at 750.

As indicated above, FIG. 7 is provided as an example. Other examples may differ from what is described with regard to FIG. 7.

FIG. 8 is a flowchart of an example method 800 of wireless communication, in accordance with the present disclosure. The method 800 may be performed at, for example, a UE (e.g., UE 120) or an apparatus of a UE.

Method 800 begins at 810 with receiving first information for a power shaping operation. For example, the UE may receive first information for a power shaping operation, as described above in connection with, for example, FIG. 6 and at 615.

Method 800 then proceeds at 820 with performing, for a codebook and in accordance with the first information, the power shaping operation for each codeword from a set of codewords included in the codebook. For example, the UE may perform, for a codebook and in accordance with the first information, the power shaping operation for each codeword from a set of codewords included in the codebook, as described above in connection with, for example, FIG. 6 and at 620.

Method 800 then proceeds at 830 with receiving second information for a power control operation. For example, the UE may receive second information for a power control operation, as described above in connection with, for example, FIG. 6 and at 625.

Method 800 then proceeds at 840 with performing, for the codebook, the power control operation in accordance with the second information, the power control operation being common to all codewords included in the codebook. For example, the UE may perform, for the codebook, the power control operation in accordance with the second information, the power control operation being common to all codewords included in the codebook, as described above in connection with, for example, FIG. 6 and at 630.

Method 800 then proceeds at 850 with transmitting, in accordance with the power shaping operation and the power control operation, control channel data that is encoded using the codebook. For example, the UE may transmit, in accordance with the power shaping operation and the power control operation, control channel data that is encoded using the codebook, as described above in connection with, for example, FIG. 6 and at 640.

In some aspects, performing the power control operation in accordance with the second information causes one or more transmit power parameters of the control channel data to meet one or more performance parameters.

In some aspects, the one or more performance parameters are associated with the power shaping operation.

In some aspects, the one or more performance parameters include at least one of an average traffic-to-pilot ratio, or an unequal error protection parameter for hybrid automatic repeat request information.

In some aspects, receiving the first information includes receiving an indication of a step gap indicative of a difference between two or more power levels in a codeword power vector.

In some aspects, receiving the indication of the step gap includes receiving an indication of a prior associated with the codebook, the prior being indicative of the step gap.

In some aspects, performing the power shaping operation includes obtaining, using a scaling factor, modified power shaping parameters for respective codewords from the set of codewords, the scaling factor being associated with an average power level of the codebook.

In some aspects, performing the power control operation includes modifying a codeword power vector associated with the codebook using a transmit power value that is associated with the codebook and a performance parameter.

In some aspects, the performance parameter is an unequal error protection parameter for hybrid automatic repeat request information.

In some aspects, the control channel data is included in a control channel transmission, and performing the power control operation includes modifying, using the transmit power value, a transmit power of one or more pilot signals included in the control channel transmission.

In some aspects, receiving the first information includes receiving an indication of a prior associated with the codebook, the prior being indicative of the transmit power value.

In some aspects, method 800 includes obtaining the transmit power value in association with a source entropy of a control channel associated with the control channel data.

In some aspects, receiving the second information includes receiving a control communication including the second information, the control communication indicating that the second information is associated with power control for only the codebook.

In some aspects, the codebook is associated with HARQ information, and the control communication indicates that the second information is associated with power control for only the HARQ information.

In some aspects, the control communication indicates that the second information is associated with the power control for only the codeword via the control communication being associated with a format that indicates that the power control is for only the codebook.

In some aspects, the control communication indicates that the second information is associated with the power control for only the codeword via the second information being included in a field that indicates that the power control is for only the codebook.

In some aspects, the control communication is a group-common control communication.

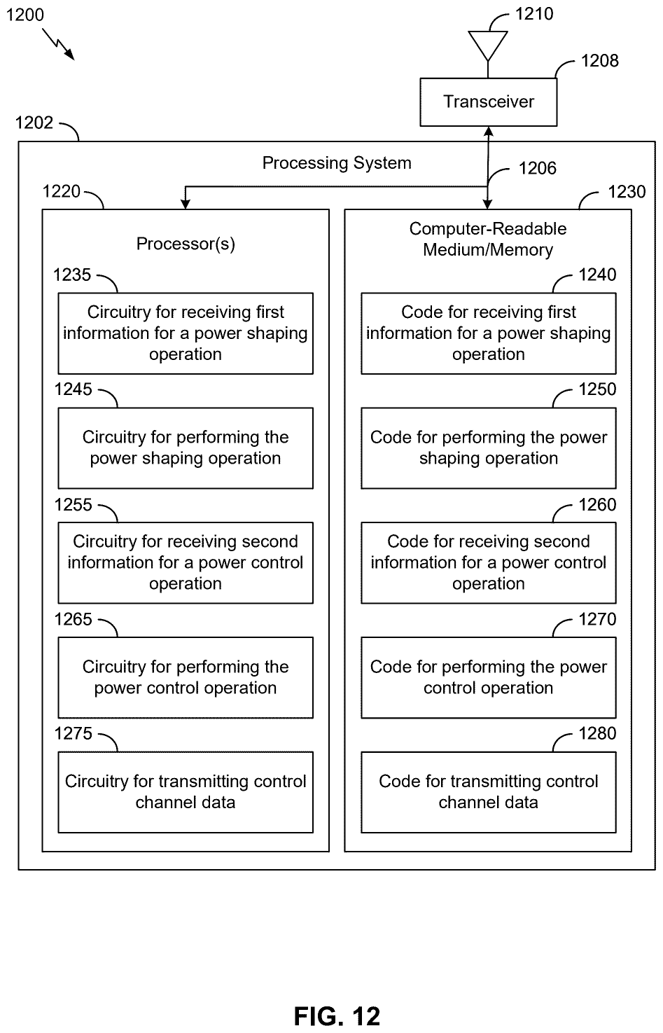

In one aspect, method 800, or any aspect related to it, may be performed by an apparatus, such as communications device 1200 of FIG. 12, which includes various components operable, configured, or adapted to perform the method 800. Communications device 1200 is described below in further detail.

Although FIG. 8 shows example blocks of method 800, in some aspects, method 800 may include additional blocks, fewer blocks, different blocks, or differently arranged blocks than those depicted in FIG. 8. Additionally, or alternatively, two or more of the blocks of method 800 may be performed in parallel.

FIG. 9 is a flowchart of an example method 900 of wireless communication, in accordance with the present disclosure. The method 900 may be performed at, for example, a network node (e.g., network node 110) or an apparatus of a network node.

Method 900 begins at 910 with transmitting, for a UE, first information for a power shaping operation. For example, the network node may transmit, for a UE, first information for a power shaping operation, as described above in connection with, for example, FIG. 6 and at 615.

Method 900 then proceeds at 920 with performing, for a codebook and in accordance with the first information, the power shaping operation for each codeword from a set of codewords included in the codebook. For example, the network node may perform, for a codebook and in accordance with the first information, the power shaping operation for each codeword from a set of codewords included in the codebook, as described above in connection with, for example, FIG. 6 and at 620.

Method 900 then proceeds at 930 with transmitting second information for a power control operation. For example, the network node may transmit second information for a power control operation, as described above in connection with, for example, FIG. 6 and at 625.

Method 900 then proceeds at 940 with performing, for the codebook, the power control operation in accordance with the second information, the power control operation being common to all codewords included in the codebook. For example, the network node may perform, for the codebook, the power control operation in accordance with the second information, the power control operation being common to all codewords included in the codebook, as described above in connection with, for example, FIG. 6 and at 630.

Method 900 then proceeds at 950 with receiving, in accordance with the power shaping operation and the power control operation, a control channel data that is encoded using the codebook. For example, the network node may receive, in accordance with the power shaping operation and the power control operation, a control channel data that is encoded using the codebook, as described above in connection with, for example, FIG. 6 and at 640.

In some aspects, performing the power control operation in accordance with the second information causes one or more transmit power parameters of the control channel data to meet one or more performance parameters.

In some aspects, the one or more performance parameters are associated with the power shaping operation.

In some aspects, the one or more performance parameters include at least one of an average traffic-to-pilot ratio, or an unequal error protection parameter for hybrid automatic repeat request information.

In some aspects, transmitting the first information includes transmitting an indication of a step gap indicative of a difference between two or more power levels included in a codeword power vector associated with the power shaping operation.

In some aspects, transmitting the indication of the step gap includes transmitting an indication of a prior associated with the codebook, the prior being indicative of the step gap.

In some aspects, performing the power shaping operation includes obtaining, using a scaling factor, modified power shaping parameters for respective codewords from the set of codewords, the scaling factor being associated with an average power level of the codebook.

In some aspects, performing the power control operation includes modifying a codeword power vector associated with the codebook using a transmit power value that is associated with the codebook and a performance parameter.

In some aspects, the performance parameter is an unequal error protection parameter for hybrid automatic repeat request information.

In some aspects, the control channel data is included in a control channel transmission, and performing the power control operation includes modifying, using the transmit power value, a transmit power of one or more pilot signals included in the control channel transmission.

In some aspects, transmitting the first information includes transmitting an indication of a prior associated with the codebook, the prior being indicative of the transmit power value.

In some aspects, method 900 includes obtaining the transmit power value in association with a source entropy of a control channel associated with the control channel data.

In some aspects, transmitting the second information includes transmitting a control communication including the second information, the control communication indicating that the second information is associated with power control for only the codebook.

In some aspects, the codebook is associated with HARQ information, and the control communication indicates that the second information is associated with power control for only the HARQ information.

In some aspects, the control communication indicates that the second information is associated with the power control for only the codeword via the control communication being associated with a format that indicates that the power control is for only the codebook.

In some aspects, the control communication indicates that the second information is associated with the power control for only the codeword via the second information being included in a field that indicates that the power control is for only the codebook.

In some aspects, the control communication is a group-common control communication.

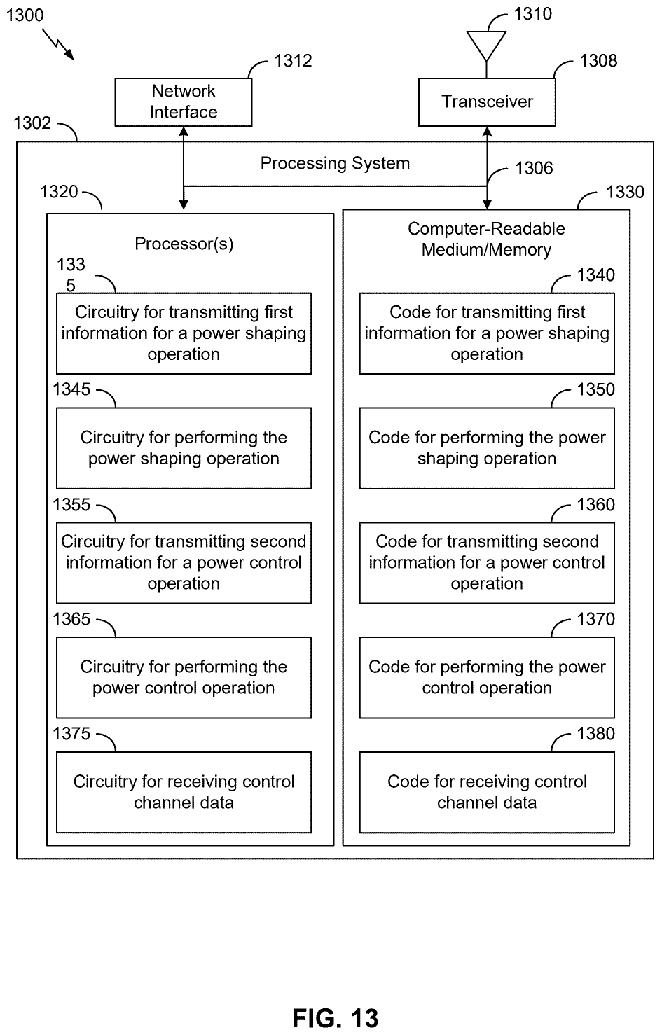

In one aspect, method 900, or any aspect related to it, may be performed by an apparatus, such as communications device 1300 of FIG. 13, which includes various components operable, configured, or adapted to perform the method 900. Communications device 1300 is described below in further detail.

Although FIG. 9 shows example blocks of method 900, in some aspects, method 900 may include additional blocks, fewer blocks, different blocks, or differently arranged blocks than those depicted in FIG. 9. Additionally, or alternatively, two or more of the blocks of method 900 may be performed in parallel.

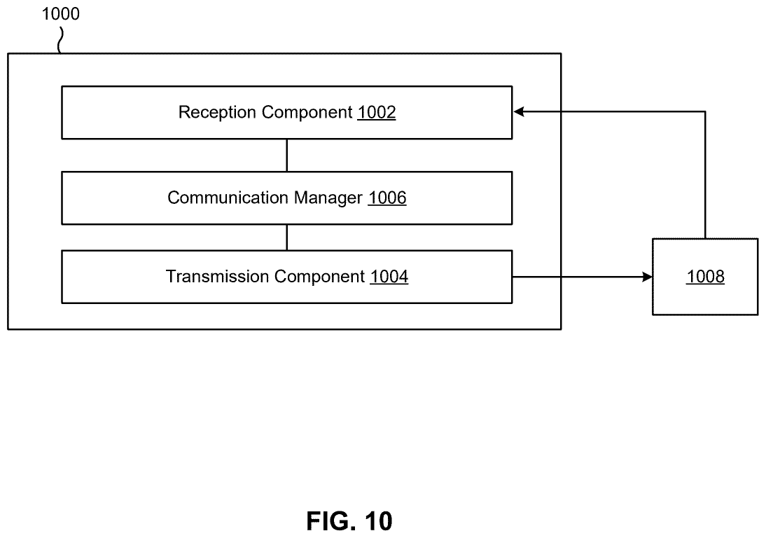

FIG. 10 is a diagram of an example apparatus 1000 for wireless communication, in accordance with the present disclosure. The apparatus 1000 may be a UE, or a UE may include the apparatus 1000. In some aspects, the apparatus 1000 includes a reception component 1002, a transmission component 1004, and/or a communication manager 1006, which may be in communication with one another (for example, via one or more buses and/or one or more other components). In some aspects, the communication manager 1006 is the communication manager 140 described in connection with FIG. 1. As shown, the apparatus 1000 may communicate with another apparatus 1008, such as a UE or a network node (such as a CU, a DU, an RU, or a base station), using the reception component 1002 and the transmission component 1004.

In some aspects, the apparatus 1000 may be configured to perform one or more operations described herein in connection with FIGS. 6 an 7. Additionally, or alternatively, the apparatus 1000 may be configured to perform one or more processes described herein, such as method 800 of FIG. 8, or a combination thereof. In some aspects, the apparatus 1000 and/or one or more components shown in FIG. 10 may include one or more components of the UE described in connection with FIG. 1 and FIG. 2. Additionally, or alternatively, one or more components shown in FIG. 10 may be implemented within one or more components described in connection with FIG. 1 and FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, one or more modems, one or more demodulators, one or more MIMO detectors, one or more receive processors, one or more controllers/processors, one or more memories, or a combination thereof, of the UE described in connection with FIG. 1 and FIG. 2.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1008. In some aspects, the transmission component 1004 may include one or more antennas, one or more modems, one or more modulators, one or more transmit MIMO processors, one or more transmit processors, one or more controllers/processors, one or more memories, or a combination thereof, of the UE described in connection with FIG. 1 and FIG. 2. In some aspects, the transmission component 1004 may be co-located with the reception component 1002 in one or more transceivers.

The communication manager 1006 may support operations of the reception component 1002 and/or the transmission component 1004. For example, the communication manager 1006 may receive information associated with configuring reception of communications by the reception component 1002 and/or transmission of communications by the transmission component 1004. Additionally, or alternatively, the communication manager 1006 may generate and/or provide control information to the reception component 1002 and/or the transmission component 1004 to control reception and/or transmission of communications.

The reception component 1002 may receive first information for a power shaping operation. The communication manager 1006 may perform, for a codebook and in accordance with the first information, the power shaping operation for each codeword from a set of codewords included in the codebook. The reception component 1002 may receive second information for a power control operation. The communication manager 1006 may perform, for the codebook, the power control operation in accordance with the second information, the power control operation being common to all codewords included in the codebook. The transmission component 1004 may transmit, in accordance with the power shaping operation and the power control operation, control channel data that is encoded using the codebook.

The reception component 1002 may obtain the transmit power value in association with a source entropy of a control channel associated with the control channel data.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

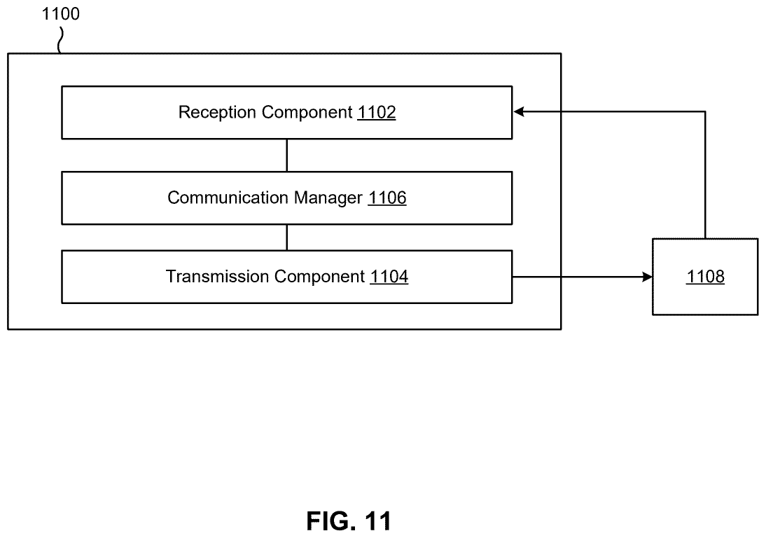

FIG. 11 is a diagram of an example apparatus 1100 for wireless communication, in accordance with the present disclosure. The apparatus 1100 may be a network node, or a network node may include the apparatus 1100. In some aspects, the apparatus 1100 includes a reception component 1102, a transmission component 1104, and/or a communication manager 1106, which may be in communication with one another (for example, via one or more buses and/or one or more other components). In some aspects, the communication manager 1106 is the communication manager 150 described in connection with FIG. 1. As shown, the apparatus 1100 may communicate with another apparatus 1108, such as a UE or a network node (such as a CU, a DU, an RU, or a base station), using the reception component 1102 and the transmission component 1104.

In some aspects, the apparatus 1100 may be configured to perform one or more operations described herein in connection with FIGS. 6 and 7. Additionally, or alternatively, the apparatus 1100 may be configured to perform one or more processes described herein, such as method 900 of FIG. 9, or a combination thereof. In some aspects, the apparatus 1100 and/or one or more components shown in FIG. 11 may include one or more components of the network node described in connection with FIG. 1 and FIG. 2. Additionally, or alternatively, one or more components shown in FIG. 11 may be implemented within one or more components described in connection with FIG. 1 and FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, one or more modems, one or more demodulators, one or more MIMO detectors, one or more receive processors, one or more controllers/processors, one or more memories, or a combination thereof, of the network node described in connection with FIG. 1 and FIG. 2. In some aspects, the reception component 1102 and/or the transmission component 1104 may include or may be included in a network interface. The network interface may be configured to obtain and/or output signals for the apparatus 1100 via one or more communications links, such as a backhaul link, a midhaul link, and/or a fronthaul link.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1108. In some aspects, the transmission component 1104 may include one or more antennas, one or more modems, one or more modulators, one or more transmit MIMO processors, one or more transmit processors, one or more controllers/processors, one or more memories, or a combination thereof, of the network node described in connection with FIG. 1 and FIG. 2. In some aspects, the transmission component 1104 may be co-located with the reception component 1102 in one or more transceivers.

The communication manager 1106 may support operations of the reception component 1102 and/or the transmission component 1104. For example, the communication manager 1106 may receive information associated with configuring reception of communications by the reception component 1102 and/or transmission of communications by the transmission component 1104. Additionally, or alternatively, the communication manager 1106 may generate and/or provide control information to the reception component 1102 and/or the transmission component 1104 to control reception and/or transmission of communications.

The transmission component 1104 may transmit, for a UE, first information for a power shaping operation. The communication manager 1106 may perform, for a codebook and in accordance with the first information, the power shaping operation for each codeword from a set of codewords included in the codebook. The transmission component 1104 may transmit second information for a power control operation. The communication manager 1106 may perform, for the codebook, the power control operation in accordance with the second information, the power control operation being common to all codewords included in the codebook. The reception component 1102 may receive, in accordance with the power shaping operation and the power control operation, a control channel data that is encoded using the codebook.

The reception component 1102 may obtain the transmit power value in association with a source entropy of a control channel associated with the control channel data.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a diagram illustrating an example of an implementation of code and circuitry for a communications device 1200, in accordance with the present disclosure. The communications device 1200 may be a UE, or a UE may include the communications device 1200.

The communications device 1200 includes a processing system 1202 coupled to a transceiver 1208 (e.g., a transmitter and/or a receiver, and which may include a single transceivers or multiple transceivers which may perform different operations described as being performed by the transceiver 1208). The transceiver 1208 is configured to transmit and receive signals for the communications device 1200 via an antenna 1210, such as the various signals as described herein. The processing system 1202 may be configured to perform processing functions for the communications device 1200, including processing signals received and/or to be transmitted by the communications device 1200.

The processing system 1202 includes one or more processors 1220. In various aspects, the one or more processors 1220 may include one or more of receive processor 258, transmit processor 264, TX MIMO processor 266, and/or controller/processor 280, as described with respect to FIG. 2. The one or more processors 1220 are coupled to a computer-readable medium/memory 1230 via a bus 1206. In various aspects, the computer-readable medium/memory 1230 may include one or more memories such as memory 282, as described with respect to FIG. 2. In certain aspects, the computer-readable medium/memory 1230 is configured to store instructions (e.g., computer-executable code, processor-executable code) that when executed by the one or more processors 1220, cause the one or more processors 1220 to perform the method 800 described with respect to FIG. 8, or any aspect related to it. Note that reference to a processor performing a function of communications device 1200 may include one or more processors performing that function of communications device 1200. Note also that reference to one or more processors performing multiple functions may include a first processor performing a first function of the multiple functions and a second processor performing a second function of the multiple functions.

As shown in FIG. 12, the communications device 1200 may include circuitry for receiving first information for a power shaping operation (circuitry 1235).

As shown in FIG. 12, the communications device 1200 may include, stored in computer-readable medium/memory 1230, code for receiving first information for a power shaping operation (code 1240).

As shown in FIG. 12, the communications device 1200 may include circuitry for performing, for a codebook and in accordance with the first information, the power shaping operation for each codeword from a set of codewords included in the codebook (circuitry 1245).

As shown in FIG. 12, the communications device 1200 may include, stored in computer-readable medium/memory 1230, code for performing, for a codebook and in accordance with the first information, the power shaping operation for each codeword from a set of codewords included in the codebook (code 1250).

As shown in FIG. 12, the communications device 1200 may include circuitry for receiving second information for a power control operation (circuitry 1255).

As shown in FIG. 12, the communications device 1200 may include, stored in computer-readable medium/memory 1230, code for receiving second information for a power control operation (code 1260).

As shown in FIG. 12, the communications device 1200 may include circuitry for performing, for the codebook, the power control operation in accordance with the second information, the power control operation being common to all codewords included in the codebook (circuitry 1265).

As shown in FIG. 12, the communications device 1200 may include, stored in computer-readable medium/memory 1230, code for performing, for the codebook, the power control operation in accordance with the second information, the power control operation being common to all codewords included in the codebook (code 1270).

As shown in FIG. 12, the communications device 1200 may include circuitry for transmitting, in accordance with the power shaping operation and the power control operation, control channel data that is encoded using the codebook (circuitry 1275).

As shown in FIG. 12, the communications device 1200 may include, stored in computer-readable medium/memory 1230, code for transmitting, in accordance with the power shaping operation and the power control operation, control channel data that is encoded using the codebook (code 1280).

Various components of the communications device 1200 may provide means for performing the method 800 described with respect to FIG. 8, or any aspect related to it. For example, means for transmitting, sending, or outputting for transmission may include the transceiver(s) and/or antenna(s) 252 of the UE 120 and/or transceiver 1208 and antenna 1210 of the communications device 1200 in FIG. 12. Means for receiving or obtaining may include the transceiver(s) and/or antenna(s) 252 of the UE 120 and/or transceiver 1208 and antenna 1210 of the communications device 1200 in FIG. 12.

FIG. 12 is provided as an example. Other examples may differ from what is described in connection with FIG. 12.

FIG. 13 is a diagram illustrating an example of an implementation of code and circuitry for a communications device 1300, in accordance with the present disclosure. The communications device 1300 may be a network node (such as network node 110 or a disaggregated base station as described with regard to FIG. 3), or a network node may include the communications device 1300.

The communications device 1300 includes a processing system 1302 coupled to a transceiver 1308 (e.g., a transmitter and/or a receiver, and which may include a single transceivers or multiple transceivers which may perform different operations described as being performed by the transceiver 1308). The transceiver 1308 is configured to transmit and receive signals for the communications device 1300 via an antenna 1310 (e.g., one or more antennas), such as the various signals as described herein. The network interface 1312 is configured to obtain and send signals for the communications device 1300 via communications link(s), such as a backhaul link, midhaul link, and/or fronthaul link as described herein, such as with respect to FIG. 3. The processing system 1302 may be configured to perform processing functions for the communications device 1300, including processing signals received and/or to be transmitted by the communications device 1300.

The processing system 1302 includes one or more processors 1320. In various aspects, the one or more processors 1320 may include one or more of receive processor 238, transmit processor 220, TX MIMO processor 230, and/or controller/processor 240, as described with respect to FIG. 2. The one or more processors 1320 are coupled to a computer-readable medium/memory 1330 via a bus 1306. In various aspects, the computer-readable medium/memory 1330 may include one or more memories such as memory 242, as described with respect to FIG. 2. In certain aspects, the computer-readable medium/memory 1330 is configured to store instructions (e.g., computer-executable code, processor-executable code) that when executed by the one or more processors 1320, cause the one or more processors 1320 to perform the method 900 described with respect to FIG. 9, or any aspect related to it. Note that reference to a processor performing a function of communications device 1300 may include one or more processors performing that function of communications device 1300. Note also that reference to one or more processors performing multiple functions may include a first processor performing a first function of the multiple functions and a second processor performing a second function of the multiple functions.

As shown in FIG. 13, the communications device 1300 may include circuitry for transmitting, for a UE, first information for a power shaping operation (circuitry 1335).

As shown in FIG. 13, the communications device 1300 may include, stored in computer-readable medium/memory 1330, code for transmitting, for a UE, first information for a power shaping operation (code 1340).

As shown in FIG. 13, the communications device 1300 may include circuitry for performing, for a codebook and in accordance with the first information, the power shaping operation for each codeword from a set of codewords included in the codebook (circuitry 1345).

As shown in FIG. 13, the communications device 1300 may include, stored in computer-readable medium/memory 1330, code for performing, for a codebook and in accordance with the first information, the power shaping operation for each codeword from a set of codewords included in the codebook (code 1350).

As shown in FIG. 13, the communications device 1300 may include circuitry for transmitting second information for a power control operation (circuitry 1355).

As shown in FIG. 13, the communications device 1300 may include, stored in computer-readable medium/memory 1330, code for transmitting second information for a power control operation (code 1360).

As shown in FIG. 13, the communications device 1300 may include circuitry for performing, for the codebook, the power control operation in accordance with the second information, the power control operation being common to all codewords included in the codebook (circuitry 1365).

As shown in FIG. 13, the communications device 1300 may include, stored in computer-readable medium/memory 1330, code for performing, for the codebook, the power control operation in accordance with the second information, the power control operation being common to all codewords included in the codebook (code 1370).

As shown in FIG. 13, the communications device 1300 may include circuitry for receiving, in accordance with the power shaping operation and the power control operation, a control channel data that is encoded using the codebook (circuitry 1375).

As shown in FIG. 13, the communications device 1300 may include, stored in computer-readable medium/memory 1330, code for receiving, in accordance with the power shaping operation and the power control operation, a control channel data that is encoded using the codebook (code 1380).

Various components of the communications device 1300 may provide means for performing the method 900 described with respect to FIG. 9, or any aspect related to it. For example, means for transmitting, sending, or outputting for transmission May include the transceiver(s) and/or antenna(s) 234 of the network node 110 and/or the transceiver 1308 and/or antenna 1310 of the communications device 1300 in FIG. 13. Means for receiving or obtaining may include the transceiver(s) and/or antenna(s) 234 of the network node 110 and/or the transceiver 1308 and/or antenna 1310 of the communications device 1300 in FIG. 13.

FIG. 13 is provided as an example. Other examples may differ from what is described in connection with FIG. 13.

The following provides an overview of some Aspects of the present disclosure:

Aspect 1: A method of wireless communication performed by a user equipment (UE), comprising: receiving first information for a power shaping operation; performing, for a codebook and in accordance with the first information, the power shaping operation for each codeword from a set of codewords included in the codebook; receiving second information for a power control operation; performing, for the codebook, the power control operation in accordance with the second information, the power control operation being common to all codewords included in the codebook; and transmitting, in accordance with the power shaping operation and the power control operation, control channel data that is encoded using the codebook.

Aspect 2: The method of Aspect 1, wherein performing the power control operation in accordance with the second information causes one or more transmit power parameters of the control channel data to meet one or more performance parameters.

Aspect 3: The method of Aspect 2, wherein the one or more performance parameters are associated with the power shaping operation.

Aspect 4: The method of any of Aspects 2-3, wherein the one or more performance parameters include at least one of: an average traffic-to-pilot ratio, or an unequal error protection parameter for hybrid automatic repeat request information.

Aspect 5: The method of any of Aspects 1-4, wherein receiving the first information comprises: receiving an indication of a step gap indicative of a difference between two or more power levels in a codeword power vector.

Aspect 6: The method of Aspect 5, wherein receiving the indication of the step gap comprises: receiving an indication of a prior associated with the codebook, the prior being indicative of the step gap.

Aspect 7: The method of any of Aspects 1-6, wherein performing the power shaping operation comprises: obtaining, using a scaling factor, modified power shaping parameters for respective codewords from the set of codewords, the scaling factor being associated with an average power level of the codebook.

Aspect 8: The method of any of Aspects 1-7, wherein performing the power control operation comprises: modifying a codeword power vector associated with the codebook using a transmit power value that is associated with the codebook and a performance parameter.

Aspect 9: The method of Aspect 8, wherein the performance parameter is an unequal error protection parameter for hybrid automatic repeat request information.

Aspect 10: The method of any of Aspects 8-9, wherein the control channel data is included in a control channel transmission, and wherein performing the power control operation comprises: modifying, using the transmit power value, a transmit power of one or more pilot signals included in the control channel transmission.

Aspect 11: The method of any of Aspects 8-10, wherein receiving the first information comprises: receiving an indication of a prior associated with the codebook, the prior being indicative of the transmit power value.

Aspect 12: The method of any of Aspects 8-11, comprising: obtaining the transmit power value in association with a source entropy of a control channel associated with the control channel data.

Aspect 13: The method of any of Aspects 1-12, wherein receiving the second information comprises: receiving a control communication including the second information, the control communication indicating that the second information is associated with power control for only the codebook.

Aspect 14: The method of Aspect 13, wherein the codebook is associated with hybrid automatic repeat request (HARQ) information, and wherein the control communication indicates that the second information is associated with power control for only the HARQ information.

Aspect 15: The method of any of Aspects 13-14, wherein the control communication indicates that the second information is associated with the power control for only the codeword via the control communication being associated with a format that indicates that the power control is for only the codebook.

Aspect 16: The method of any of Aspects 13-15, wherein the control communication indicates that the second information is associated with the power control for only the codeword via the second information being included in a field that indicates that the power control is for only the codebook.

Aspect 17: The method of any of Aspects 13-16, wherein the control communication is a group-common control communication.

Aspect 18: A method of wireless communication performed by a network node, comprising: transmitting, for a user equipment (UE), first information for a power shaping operation; performing, for a codebook and in accordance with the first information, the power shaping operation for each codeword from a set of codewords included in the codebook; transmitting second information for a power control operation; performing, for the codebook, the power control operation in accordance with the second information, the power control operation being common to all codewords included in the codebook; and receiving, in accordance with the power shaping operation and the power control operation, a control channel data that is encoded using the codebook.

Aspect 19: The method of Aspect 18, wherein performing the power control operation in accordance with the second information causes one or more transmit power parameters of the control channel data to meet one or more performance parameters.

Aspect 20: The method of Aspect 19, wherein the one or more performance parameters are associated with the power shaping operation.

Aspect 21: The method of any of Aspects 19-20, wherein the one or more performance parameters include at least one of: an average traffic-to-pilot ratio, or an unequal error protection parameter for hybrid automatic repeat request information.

Aspect 22: The method of any of Aspects 18-21, wherein transmitting the first information comprises: transmitting an indication of a step gap indicative of a difference between two or more power levels included in a codeword power vector associated with the power shaping operation.

Aspect 23: The method of Aspect 22, wherein transmitting the indication of the step gap comprises: transmitting an indication of a prior associated with the codebook, the prior being indicative of the step gap.

Aspect 24: The method of any of Aspects 18-23, wherein performing the power shaping operation comprises: obtaining, using a scaling factor, modified power shaping parameters for respective codewords from the set of codewords, the scaling factor being associated with an average power level of the codebook.

Aspect 25: The method of any of Aspects 18-24, wherein performing the power control operation comprises: modifying a codeword power vector associated with the codebook using a transmit power value that is associated with the codebook and a performance parameter.

Aspect 26: The method of Aspect 25, wherein the performance parameter is an unequal error protection parameter for hybrid automatic repeat request information.

Aspect 27: The method of any of Aspects 25-26, wherein the control channel data is included in a control channel transmission, and wherein performing the power control operation comprises: modifying, using the transmit power value, a transmit power of one or more pilot signals included in the control channel transmission.

Aspect 28: The method of any of Aspects 25-27, wherein transmitting the first information comprises: transmitting an indication of a prior associated with the codebook, the prior being indicative of the transmit power value.

Aspect 29: The method of any of Aspects 25-28, comprising: obtaining the transmit power value in association with a source entropy of a control channel associated with the control channel data.

Aspect 30: The method of any of Aspects 18-29, wherein transmitting the second information comprises: transmitting a control communication including the second information, the control communication indicating that the second information is associated with power control for only the codebook.

Aspect 31: The method of Aspect 30, wherein the codebook is associated with hybrid automatic repeat request (HARQ) information, and wherein the control communication indicates that the second information is associated with power control for only the HARQ information.

Aspect 32: The method of any of Aspects 30-31, wherein the control communication indicates that the second information is associated with the power control for only the codeword via the control communication being associated with a format that indicates that the power control is for only the codebook.

Aspect 33: The method of any of Aspects 30-32, wherein the control communication indicates that the second information is associated with the power control for only the codeword via the second information being included in a field that indicates that the power control is for only the codebook.

Aspect 34: The method of any of Aspects 30-33, wherein the control communication is a group-common control communication.

Aspect 35: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-34.

Aspect 36: An apparatus for wireless communication at a device, the apparatus comprising one or more memories and one or more processors coupled to the one or more memories, the one or more processors configured to cause the device to perform the method of one or more of Aspects 1-34.

Aspect 37: An apparatus for wireless communication, the apparatus comprising at least one means for performing the method of one or more of Aspects 1-34.

Aspect 38: A non-transitory computer-readable medium storing code for wireless communication, the code comprising instructions executable by one or more processors to perform the method of one or more of Aspects 1-34.

Aspect 39: A non-transitory computer-readable medium storing a set of instructions for wireless communication, the set of instructions comprising one or more instructions that, when executed by one or more processors of a device, cause the device to perform the method of one or more of Aspects 1-34.

Aspect 40: A device for wireless communication, the device comprising a processing system that includes one or more processors and one or more memories coupled with the one or more processors, the processing system configured to cause the device to perform the method of one or more of Aspects 1-34.

Aspect 41: An apparatus for wireless communication at a device, the apparatus comprising one or more memories and one or more processors coupled to the one or more memories, the one or more processors individually or collectively configured to cause the device to perform the method of one or more of Aspects 1-34.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based on or otherwise in association with” unless explicitly stated otherwise. Also, as used herein, the term “or” is intended to be inclusive when used in a series and may be used interchangeably with “and/or,” unless explicitly stated otherwise (for example, if used in combination with “either” or “only one of”). It should be understood that “one or more” is equivalent to “at least one.”

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set.

What is claimed is:

1. An apparatus configured for wireless communication, comprising:
one or more memories comprising processor-executable instructions; and
one or more processors configured to execute the processor-executable instructions and cause the apparatus to:
receive first information for a power shaping operation;
perform, for a codebook and in accordance with the first information, the power shaping operation for each codeword from a set of codewords included in the codebook;
receive second information for a power control operation;
perform, for the codebook, the power control operation in accordance with the second information, the power control operation being common to all codewords included in the codebook; and
transmit, in accordance with the power shaping operation and the power control operation, control channel data that is encoded using the codebook.

2. The apparatus of claim 1, wherein performing the power control operation in accordance with the second information causes one or more transmit power parameters of the control channel data to meet one or more performance parameters.

3. The apparatus of claim 2, wherein the one or more performance parameters are associated with the power shaping operation.

4. The apparatus of claim 2, wherein the one or more performance parameters include at least one of:
an average traffic-to-pilot ratio, or
an unequal error protection parameter for hybrid automatic repeat request information.

5. The apparatus of claim 1, wherein the one or more processors, to cause the apparatus to receive the first information, are configured to cause the apparatus to:
receive an indication of a step gap indicative of a difference between two or more power levels in a codeword power vector.

6. The apparatus of claim 5, wherein the one or more processors, to cause the apparatus to receive the indication of the step gap, are configured to cause the apparatus to:
receive an indication of a prior associated with the codebook, the prior being indicative of the step gap.

7. The apparatus of claim 1, wherein the one or more processors, to cause the apparatus to perform the power shaping operation, are configured to cause the apparatus to:
obtain, using a scaling factor, modified power shaping parameters for respective codewords from the set of codewords, the scaling factor being associated with an average power level of the codebook.

8. The apparatus of claim 1, wherein the one or more processors, to cause the apparatus to perform the power control operation, are configured to cause the apparatus to:
modify a codeword power vector associated with the codebook using a transmit power value that is associated with the codebook and a performance parameter.

9. The apparatus of claim 8, wherein the performance parameter is an unequal error protection parameter for hybrid automatic repeat request information.

10. The apparatus of claim 8, wherein the control channel data is included in a control channel transmission, and wherein the one or more processors, to cause the apparatus to perform the power control operation, are configured to cause the apparatus to:
modify, using the transmit power value, a transmit power of one or more pilot signals included in the control channel transmission.

11. The apparatus of claim 8, wherein the one or more processors, to cause the apparatus to receive the first information, are configured to cause the apparatus to:
receive an indication of a prior associated with the codebook, the prior being indicative of the transmit power value.

12. The apparatus of claim 8, wherein the one or more processors are configured to cause the apparatus to:
obtain the transmit power value in association with a source entropy of a control channel associated with the control channel data.

13. The apparatus of claim 1, wherein the one or more processors, to cause the apparatus to receive the second information, are configured to cause the apparatus to:
receive a control communication including the second information, the control communication indicating that the second information is associated with power control for only the codebook.

14. The apparatus of claim 13, wherein the codebook is associated with hybrid automatic repeat request (HARQ) information, and wherein the control communication indicates that the second information is associated with power control for only the HARQ information.

15. The apparatus of claim 13, wherein the control communication indicates that the second information is associated with the power control for only the codeword via the control communication being associated with a format that indicates that the power control is for only the codebook.

16. The apparatus of claim 13, wherein the control communication indicates that the second information is associated with the power control for only the codeword via the second information being included in a field that indicates that the power control is for only the codebook.

17. The apparatus of claim 13, wherein the control communication is a group-common control communication.

18. An apparatus configured for wireless communication, comprising:
one or more memories comprising processor-executable instructions; and
one or more processors configured to execute the processor-executable instructions and cause the apparatus to:
transmit, for a user equipment (UE), first information for a power shaping operation;
perform, for a codebook and in accordance with the first information, the power shaping operation for each codeword from a set of codewords included in the codebook;
transmit second information for a power control operation;
perform, for the codebook, the power control operation in accordance with the second information, the power control operation being common to all codewords included in the codebook; and
receive, in accordance with the power shaping operation and the power control operation, a control channel data that is encoded using the codebook.

19. The apparatus of claim 18, wherein performing the power control operation in accordance with the second information is configured to cause one or more transmit power parameters of the control channel data to meet one or more performance parameters.

20. The apparatus of claim 19, wherein the one or more performance parameters include at least one of:
an average traffic-to-pilot ratio, or
an unequal error protection parameter for hybrid automatic repeat request information.

21. The apparatus of claim 18, wherein the one or more processors, to cause the apparatus to transmit the first information, are configured to cause the apparatus to:
transmit an indication of a step gap indicative of a difference between two or more power levels included in a codeword power vector associated with the power shaping operation.

22. The apparatus of claim 21, wherein the one or more processors, to cause the apparatus to transmit the indication of the step gap, are configured to cause the apparatus to:
transmit an indication of a prior associated with the codebook, the prior being indicative of the step gap.

23. The apparatus of claim 18, wherein the one or more processors, to cause the apparatus to perform the power shaping operation, are configured to cause the apparatus to:
obtain, using a scaling factor, modified power shaping parameters for respective codewords from the set of codewords, the scaling factor being associated with an average power level of the codebook.

24. The apparatus of claim 18, wherein the one or more processors, to cause the apparatus to perform the power control operation, are configured to cause the apparatus to:
modify a codeword power vector associated with the codebook using a transmit power value that is associated with the codebook and a performance parameter.

25. The apparatus of claim 24, wherein the control channel data is included in a control channel transmission, and wherein the one or more processors, to cause the apparatus to perform the power control operation, are configured to cause the apparatus to:
modify, using the transmit power value, a transmit power of one or more pilot signals included in the control channel transmission.

26. The apparatus of claim 24, wherein the one or more processors, to cause the apparatus to transmit the first information, are configured to cause the apparatus to:
transmit an indication of a prior associated with the codebook, the prior being indicative of the transmit power value.

27. The apparatus of claim 24, wherein the one or more processors are configured to cause the apparatus to:
obtain the transmit power value in association with a source entropy of a control channel associated with the control channel data.

28. The apparatus of claim 18, wherein the one or more processors, to cause the apparatus to transmit the second information, are configured to cause the apparatus to:
transmit a control communication including the second information, the control communication indicating that the second information is associated with power control for only the codebook.

29. A method of wireless communication performed by a user equipment (UE), comprising:
receiving first information for a power shaping operation;
performing, for a codebook and in accordance with the first information, the power shaping operation for each codeword from a set of codewords included in the codebook;
receiving second information for a power control operation;
performing, for the codebook, the power control operation in accordance with the second information, the power control operation being common to all codewords included in the codebook; and
transmitting, in accordance with the power shaping operation and the power control operation, control channel data that is encoded using the codebook.

30. A method of wireless communication performed by a network node, comprising:
transmitting, for a user equipment (UE), first information for a power shaping operation;
performing, for a codebook and in accordance with the first information, the power shaping operation for each codeword from a set of codewords included in the codebook;
transmitting second information for a power control operation;
performing, for the codebook, the power control operation in accordance with the second information, the power control operation being common to all codewords included in the codebook; and
receiving, in accordance with the power shaping operation and the power control operation, a control channel data that is encoded using the codebook.
